(19) United States
(12) Patent Application Publication
(10) Pub. No.: US 2022/0312692 A1
(43) Pub. Date: Oct. 6, 2022

(54) UNDERSEA TUNNEL SYSTEM FOR REDUCING TYPHOON, HURRICANE, AND TORNADO DISASTERS

(71) Applicant: Youngchul YANG, Seoul (KR)

(72) Inventor: Youngchul YANG, Seoul (KR)

(21) Appl. No.: 17/614,419

(22) PCT Filed: Dec. 22, 2020
(86) PCT No.: PCT/KR2020/018904

§ 371 Date: Nov. 26, 2021

(30) Foreign Application Priority Data
Dec. 24, 2019 (KR) 10-2019-0173629

(51) Int. Cl. A01G 15/00; G01W 1/10; E02D 29/063; E02B 3/00

(52) U.S. Cl. CPC A01G 15/00; G01W 1/10; E02D 29/063; E02B 3/00

(57) ABSTRACT

Provided is an undersea tunnel system for reducing typhoon, hurricane, and tornado disasters. The undersea tunnel system for dispersing to weaken or preventing collection of tropical low pressure by reducing typhoon, hurricane, and tornado disasters comprises: an undersea tunnel through which a warm surface current or seawater of a high temperature can pass; a floodgate capable of controlling the entrance and exit of the seawater passing through the undersea tunnel; a first regulator for controlling the opening and closing of the floodgate; at least one water pressure machine (air regulator) for regulating the velocity and water pressure of the seawater passing through the undersea tunnel; and a second regulator for regulating the output of the water pressure machine (air regulator).

### TECHNICAL FIELD

The present invention relates to an undersea tunnel system for reducing typhoon, hurricane, and tornado disasters.

### BACKGROUND ART

Hurricane and typhoon are tropical cyclones that occur in the western Atlantic and eastern and western Pacific Oceans. The average annual number of hurricanes in the North Atlantic, Caribbean Sea and Gulf of Mexico is about 10, and less than the frequent of typhoons. The monthly occurrence frequency of hurricanes is similar to that of typhoons, and is the most frequent from July to October. Most hurricanes are small. The large hurricane is larger than typhoon and causes considerable damage when landing on the coast of the Gulf of Mexico. The lower the central pressure, the stronger the maximum wind speed, and the generated structure is similar to that of typhoon.

The tropical cyclones ascending due to self-rotation are called Cyclone, Hurricane, and Typhoon depending on the region. Hurricane generated by temperature and wind speed higher than typhoon and having a large occurrence radius and a high occurrence altitude occurs when the occurrence of tornado is decreased. Typhoon also occurs when the occurrence of yellow dust is decreased.

Tornadoes occur in central North America, southern South America, southeastern Asia, northwestern Europe, Australia, and southern Africa. It is known that tornado occurs when low-temperature dry westerly winds collides with high-temperature humid trade winds, however, no one knows the exact cause. For another reason tornadoes occur frequently in the United States, it is announced that the low-temperature dry continental polar air mass in Canada and the Rocky Mountains and the high-temperature humid maritime tropical air mass in the Gulf of Mexico collide with each other. The exact cause of tornadoes is still unknown. However, according to the research results so far, tornado occurs when very strong updrafts occur near strong low pressure on the ground, and downdrafts are generated in a funnel-shaped center to supplement updrafts at the outside. The tornado has the wind speed of 100 m·s⁻¹ to 200 m·s⁻¹, has a vertical scale larger than a horizontal scale unlike hurricanes and typhoons.

The mechanisms of hurricanes and typhoons are the same as those of tornadoes and yellow dust. The flat-east winds affected by the superior air mass (PAM) and the surface air mass (FAM) collide with tropical cyclones caused by heat generated by the Seawater Driven Circulation (SDC), thereby generating the action of duplex worm gear (ADWG), so as to generate hurricanes and typhoons ascending (uptrend) according to the action of the right worm gear by rotating left and provide the generating energy. Hurricane occurs less frequently than typhoon, is stronger when central pressure is lower, and has the same structure as typhoon. Frequently repetitions of meteorological phenomena such as causes of El Niño and La Niña in the Gulf of Mexico and the Caribbean Sea supply energy of generating hurricanes and typhoons, and anomalies such as occurrence signs of El Niño and La Niña in the Pacific supply energy of generating hurricanes and typhoons. Typhoon is caused by temperatures and wind speeds lower than those of hurricane, and has a small occurrence radius and a low occurrence altitude. Cyclones occur in the Indian Ocean, Arabian Seas and the Gulf of Bengal, and have the occurrence scale smaller than that of typhoon.

The mechanism of tornado and yellow dust is the gear structure and gear principle, and the action of spur gear (ASG) according to the principle of spur gear (PSG) and the principle of duplex worm gear (PDWG) of westerlies, polar jet stream (PJS) and local air mass as shown in FIGS. 8 to 10, and the action of duplex worm gear (ADWG) of FIG. 5. Accordingly, the mechanisms of tornado and yellow dust, hurricane and typhoon are the same, and the occurrence energy is slightly different. As shown in FIG. 5, tornado and yellow dust occur downward (downtrend) according to the action of left worm gear. Hurricane and typhoon occur upward (uptrend).

These typhoon and hurricane disasters have repeatedly threatened human properties and lives according to the strength of the easterlies. Therefore, in order to reduce the frequency of occurrence of the above disasters and weaken the strength, the technical solution with respect to the root causes of the typhoon and hurricane disasters has been requested from the international human society.
(Patent Document 1) Korean Unexamined Patent Publication No. 10-2011-0115654 (published on Oct. 24, 2011).

### DISCLOSURE

### Technical Problem

An object to be solved by the present invention is to provide an undersea tunnel system for reducing typhoon, hurricane, and tornado disasters.

The problems to be solved by the present invention are not limited to the above-mentioned problem, and other problems not mentioned herein may be apparently understood by those skilled in the meteorological art based on the following descriptions.

### Technical Solution

In order to solve the above problems, the undersea tunnel system for reducing typhoon, hurricane, and tornado disasters according to one aspect of the present invention includes: an undersea tunnel through which seawater c an pass; a floodgate for controlling entrances and exits of the seawater, wastes, fish, and the like passing through the undersea tunnel; a first regulator for regulating openings and closings of the floodgate; at least one water pressure machine for regulating a flow rate and a water pressure of the seawater passing through the undersea tunnel; and a second regulator for regulating an output and air of the water pressure machine.

In addition, the undersea tunnel may include a grating for filtering foreign substances contained in the seawater introduced through the floodgate, a nd the first regulator may regulate openings and closings of the grating.

In addition, the material of the undersea tunnel is one of steel, concrete, and rock, depending on the conditions of the sea and topography.

In addition, the water pressure machine (air regulator) is provided with three water pressure machines installed at intervals of 2 km to 5 km in the undersea tunnel.

In addition, when the undersea tunnel is formed of rock, the inside of the tunnel is reinforced by a lining process.

In addition, the first regulator may include a water temperature detection module for detecting a water temperature, a flow rate detection module for detecting a flow rate of ocean current, a data transmission module for transmitting data collected from the water temperature detection module and the flow rate detection module to at least one external device, and a control module for adjusting the grating and the floodgate of the undersea tunnel.

In addition, the second regulator may include a water temperature detection module for detecting a water temperature, a flow rate detection module for detecting a flow rate of ocean current, and a data transmission module for transmitting data collected from the water temperature detection module a nd the flow rate detection module to at least one external device.

In addition, the undersea tunnel may include a weather condition detection module for obtaining information about water temperatures, flow rates, and weathers outside the sea level at both ends of the undersea tunnel, a data reception module for obtaining information from the first and second regulators, a data processing module for obtaining data from the weather condition detection module and the data reception module to process data about amounts of seawater passing through the undersea tunnel, and a control module for obtaining the data from the data processing module to determine operation values of the first and second regulators.

In addition, the floodgate may have at least one auxiliary floodgate con figured to be opened and closed individually even when the floodgate is close d.

In addition, the undersea tunnel may have an overall gradient in a range of 1/5000 to 1/3000. The water pressure machine may have an overall gradient in a range of 1/300 to 1/200.

Other specific details of the invention are included in the detailed description and drawings.

### Advantageous Effects

According to the description disclosed herein, movement paths of warm surface currents are blocked to disperse tropical cyclones generated and collected in the Western Pacific and Western Atlantic Oceans due to heat of the warm surface currents and northern equatorial currents, so that the frequency and intensity of typhoon and hurricane disasters caused thereby can be reduced, and the damage to human lives and properties caused by the typhoon and hurricane can be prevented.

The advantageous effects of the present invention are not limited to the effects mentioned above, and other advantageous effects not mentioned herein may be apparently understood by those skilled in the meteorological art based on the following descriptions.

### DESCRIPTION OF DRAWINGS

FIG. 1 is a representative diagram of an undersea tunnel system.

FIG. 2 is a mechanical conceptual diagram of the undersea tunnel system.

FIG. 3 schematically shows a location of an undersea tunnel of Florida Peninsula.

FIG. 4 schematically shows a location of an undersea tunnel of the New Guinea Island.

FIG. 5 schematically shows states of typhoon, hurricane, tornado and yellow dust using the principle of duplex worm gear.

FIG. 6 is a sectional view of typhoon and hurricane and shows a typhoon's eye in the center.

FIG. 7 schematically shows the mechanism of the wind driven circulation and seawater driven circulation according to the gear principle.

FIG. 8 schematically shows the action of aerodynamic force.

FIG. 9 schematically shows a right hand rule of aerodynamic force.

FIG. 10 schematically shows interaction of northern hemisphere Polar cells, Ferrel cells, and Hadley cells with jet streams.

FIG. 11 schematically shows flows of equatorial jet stream.

FIG. 12 schematically shows interaction of southern hemisphere Hadley cells, Ferrel cells, and Polar cells with jet streams.

FIG. 13 schematically shows states of the principle of sun-planet gear and the cosmic orbital pause.

FIG. 14 is a conceptual diagram of low pressure, high pressure and wind movements.

FIG. 15 schematically shows the actions of the jet streams, Polar cell, Ferrel cell and Hadley cell.

FIG. 16 schematically shows flows of jet streams.

FIG. 17 schematically shows the distribution of superior air masses.

FIG. 18 schematically shows the partial distribution of surface air masses.

FIG. 19 schematically shows the distribution of superior air masses in North America.

FIG. 20 is a view showing a state of jet streams at one time.

FIG. 21 schematically shows flows of warm surface currents.

FIG. 22 schematically shows flows of surface layer currents.

FIG. 23 is a view showing a state of sea currents around the Gulf of Mexico.

FIG. 24 is a view showing a state of sea currents around the New Guinea Island.

FIG. 25 is a view showing a state of temperatures of global sea currents.

FIG. 26 is a view showing a state of sea temperatures of the Gulf of Mexico.

FIG. 27 is a view showing a state of sea temperatures in the upper north end of South America.

FIG. 28 is a view showing a state of sea temperatures of Southeast Asia.

FIG. 29 is a part of a map of the Malay Peninsula region for the construction of an undersea tunnel.

FIG. 30 is a table showing the characteristics of typhoon, hurricane, tornado, and yellow dust.

FIG. 31 is a table related to global air motions.

FIG. 32 is a table related to distances of air motions.

FIG. 33 is a table related to the maximum and minimum values of North Sea temperatures in the New Guinea Island.

FIG. 34 is a table related to the maximum and minimum values of west sea temperatures in Ecuador.

FIG. 35 is a table related to the maximum and minimum values of North Sea temperatures in Australia.

FIG. 36 is a table related to the maximum and minimum values of east and west sea temperatures in the Florida Peninsula.

FIG. 37 is a table related to the maximum and minimum values of west sea temperatures in the Gulf of Mexico.

FIG. 38 is a table related to the maximum and minimum values of all sea temperatures in the Gulf of Mexico.

FIG. 39 is a table related to the maximum and minimum values of west sea temperatures in Mexico.

FIG. 40 is a table related to the maximum and minimum values of all sea temperatures in the Caribbean Sea.

FIG. 41 is a table related to the maximum and minimum values of northeast sea temperatures in Mexico.

FIG. 42 is a table related to the maximum and minimum values of west sea temperatures in Gabon.

### BEST MODE

### Mode for Invention

Advantages and features of the present invention, and methods for achieving the advantages and features will be apparent with reference to the embodiments described below in detail with the accompanying drawings. However, the present invention is not limited to the embodiments described as below and may be implemented in various different forms. The embodiments are provided to complete the disclosure of the present invention and to clearly teach the scope of the invention to those skilled in the meteorological art of the present invention. Therefore, the present invention will be defined only by the scope of claims.

The terms used herein are for the purpose of illustrating embodiments and the present invention is not limited thereto. In the specification herein, a singular form includes a plural form unless the context is particularly stated otherwise. The expressions used herein, “comprises” and/or “comprising” do not exclude the presence or addition of another element other than the mentioned elements. The same reference numeral indicates the same element throughout the specification, and the term “and/or” includes any one or all combinations of at least one of the mentioned elements. Although the terms such as “first”, and “second” are used to describe various elements, the elements are not limited by the terms. The above terms are used merely to distinguish one element from the other elements. Accordingly, the first element mentioned below may be the second element within the technical idea of the present invention.

Unless otherwise defined, all terms (including technical and scientific terms) used herein may be used in a sense commonly understood by those skilled in the meteorological art of the present invention. In addition, terms defined in generally used dictionaries are not ideally or excessively interpreted unless explicitly defined otherwise.

The term “unit” or “module” used herein refers to a component of software or hardware such as FPGA or ASIC and the “unit” or “module” serves predetermined roles. However, the “unit” or “module” is not limited to software or hardware. The “unit” or “module” may be configured to be disposed in an addressable storage medium, and may be configured to reproduce at least one processor. Accordingly, the “unit” or “module” as an example includes components such as software components, object-oriented software components, class components, and task components, processes, functions, attributes, procedures, subroutines, segments of program code, drivers, firmware, microcodes, circuits, data, databases, data structures, tables, arrays and variables. The functionality provided within the components and the “unit”s or “module”s may be combined into the smaller number of components and “unit” s or “module”s or further separated into additional components and “unit” s or “module”s.

The spatially relative terms such as “below”, “beneath”, “lower”, “above”, and “upper” may be used to easily describe the correlation between one component and other components as shown in the drawings. The spatially relative terms will be understood as the terms including different directions of the corresponding component when used or operated in addition to the directions shown in the drawings. For example, when a component shown in a drawing is arranged upside down, the component described as “below” or “beneath” the other component may be placed “above” the other component. Accordingly, the exemplary term “below” may include both directions “below” and “above”. The components may also be oriented in other orientations, and accordingly, the spatially relative terms may be construed according to the orientations.

Both Handed Principle of Air (BHPA).

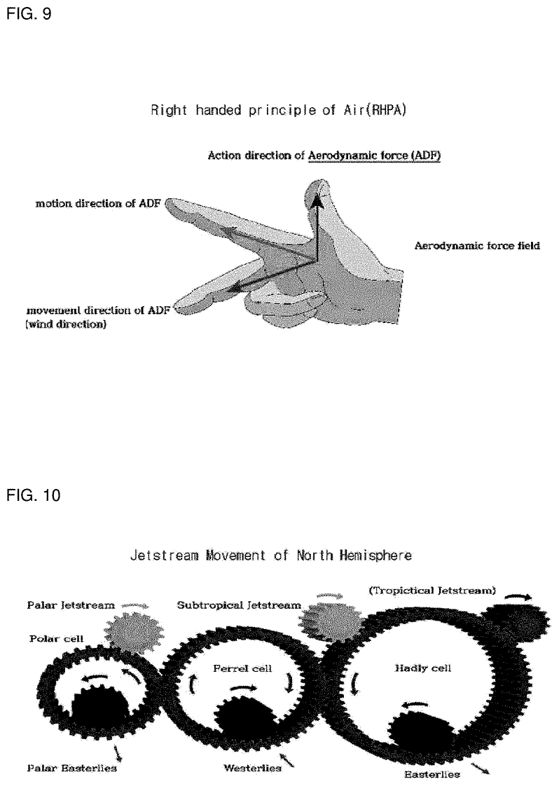

As shown in FIGS. 8 and 9, the right handed principle of air (RHPA) is established, in which when air ascends or descends in the direction of the thumb of the right hand and the air rotates in the direction of the index finger of the right hand to form an aerodynamic force field of the ascending and descending air, the movement direction (wind direction) of the ascending and descending air is the orthogonal direction (90°) of the air force field the same direction as the middle finger of the right hand, with the Handed screw rule. Conversely, since the Left handed principle of air (LHPA) is applied in the Southern Hemisphere, the both handed principle of air (BHPA) is established. As shown in FIGS. 9 and 10, the right handed principle of air (RHPA) is applied to Polar easterlies, Westerlies, Easterlies (Trade winds), High pressure, Low pressure, Polar cell, Hadley cell, and Ferrel cell in the northern hemisphere, and as shown in FIGS. 9 and 12, the Left handed principle of air (LHPA) is applied is applied in the Southern Hemisphere.

Principle of Gear (POG) and Principle of Spur Gear (PSG)

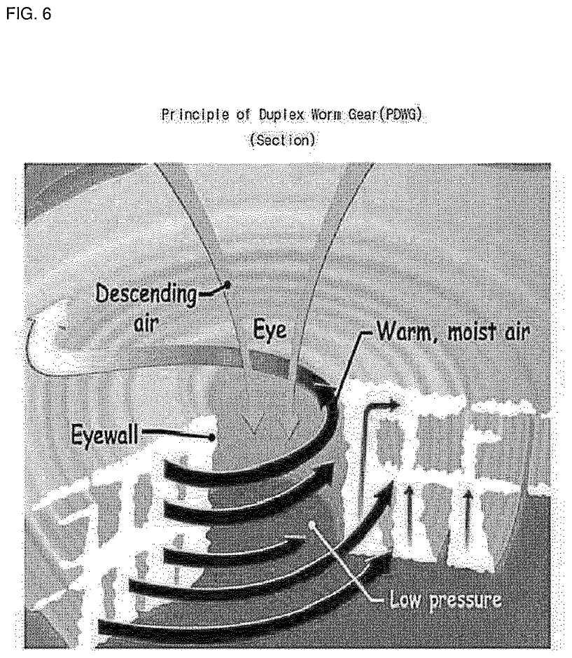

The principle of gear (POG) refers to a principle in which speeds of two gears are inversely proportional to diameters of the two gears (the ratio of the number of teeth) and directions of rotation are opposite to each other, and when another gear g₃ having the same gear diameter is installed between two gears g₁ and g₂, the speed has no change and the rotation direction of the gear g₂ is reversed due to the gear action. The principle of external gear (PEG) is the basic principle, and the spur gear refers to an external gear having teeth arranged outside the gear as shown in FIGS. 6, 7, 10 and 12, and the principle of spur gear (PSG) is applied thereto.

Principle of Duplex Worm Gear (PDWG)

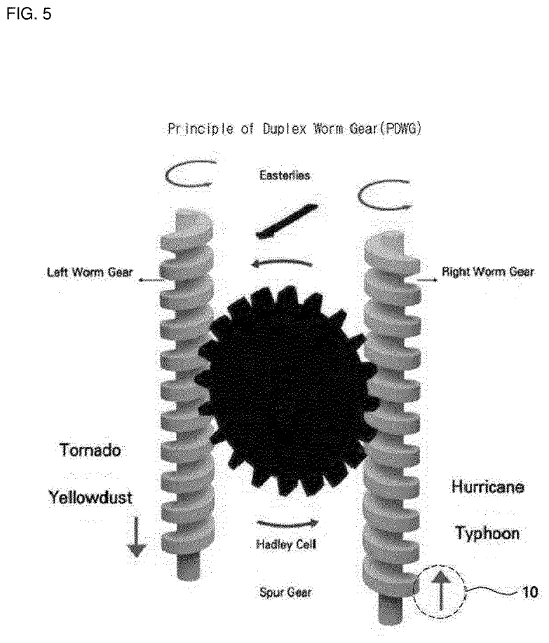

When the spur gear rotates right as shown in FIG. 5, the principle of duplex worm gear (PDWG) is established in which both of left and right worm gears with symmetrical teeth rotate left. The speed ratio between the spur gear and the worm gear is 10 to 100 times. Tornado, yellow dust, hurricane, and typhoon occur while rotating left due to the action of duplex worm gear (ADWG) of westerlies, easterlies (trade wind), and jet stream. In the northern hemisphere, air rotates to the left when ascending, and the air rotates to the right when descending.

In one embodiment, FIG. 6 may be understood as corresponding to the configuration of arrows 10 shown in FIG. 5, but the present invention is not limited thereto.

Principle of Sun-Planet Gear (PSPG)

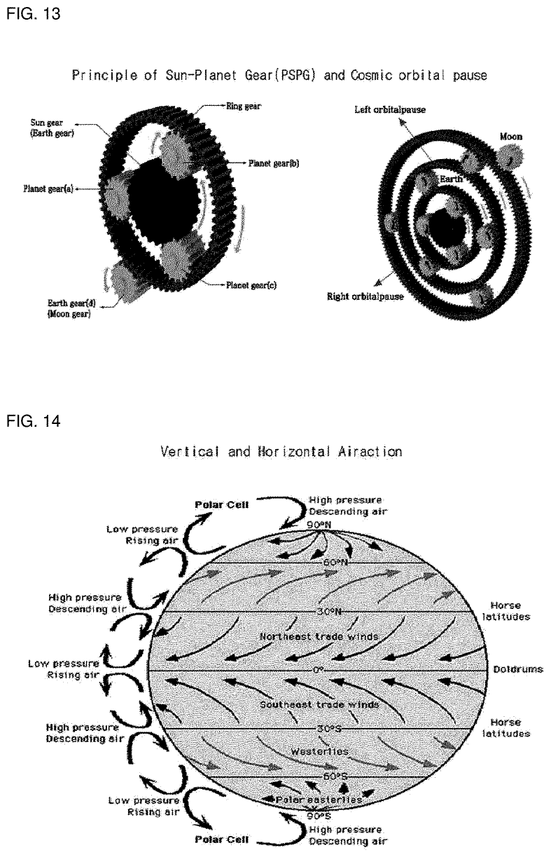

As shown in FIG. 13, the principle of sun-planet gear (PSPG) refers to a principle in which when the sun gear rotates left, the planet gears rotates left or right according to the cosmic orbital pause as shown in FIG. 13. As shown in FIG. 13, the galactic system, solar system, Sun, Mercury, Earth, Mars, Jupiter, Saturn, and Neptune rotate left like the Sun according to the principle of sun-planet gear (PSPG), and the moons of Venus, Uranus and Neptune rotate right.

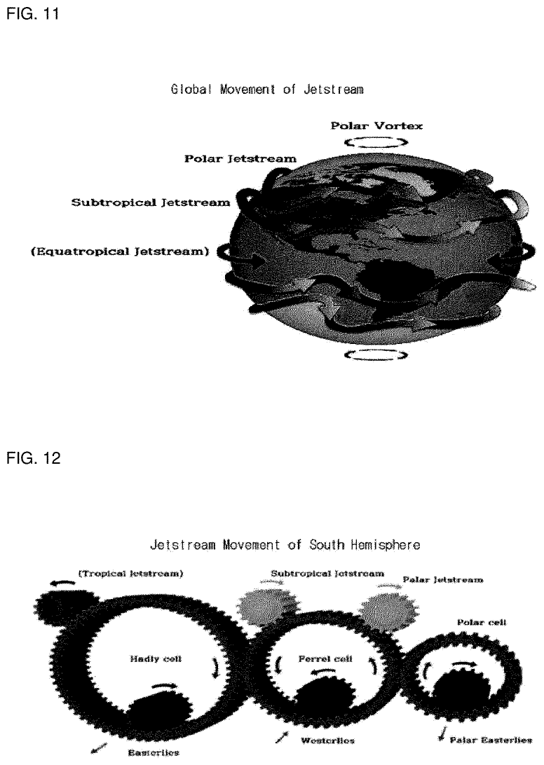

Geared Principle of Fluid and Extra Gear Fluid Seawater and air moves and shifts according to the principle of gear (POG) as shown in FIGS. 5 to 7 and 10 to 13. The geared principle of fluid (GPF) refers to a principle in which, when a rotating fluid merges with another fluid and separates into two fluids, two fluids rotate in the same direction as shown in FIG. 13 due to drag, lateral and lift forces as shown in FIG. 8 according to the principle of internal gear principle (PIG). When the action between the fluids ends extra geared fluids (EGF) such as aerodrops and raindrops that disappear soon are responsible for the action of confluence and separation. According to the geared principle of fluid (GPF), the extra gear fluids (EGF) occur in air motions and air movements related to the temperature, density, and pressure of the air. According to the geared principle of fluid (GPF) and the extra gear fluid (EGF), continuous shifts of air and seawater are possible. According to the geared principle of fluid (GPF) with aerodrops, the principle and rule for the motions and movements of air may be established.

Law of Causality (LOC)

The law of causality (LOC) refers to an inductive law of cause and effect. It is said that, after Aristotle of Greece asserted the law of causality (LOC) of induction in around 330 BC, classical physics, classical mechanics, philosophy, and ethics have tried to prove the law of causality, but some have not been proven. D. Hume of Kingdom of Great Britain argued that the relationship between cause and effect cannot be empirically derived, and it is the product of human psychology that expects similar results from similar causes through repeated experiences. I. Kant of Germany argued that the relationship between cause and effect is a subjective and innate relationship under the precondition of experience (experience, science, and objective knowledge). Materialism and dialectical materialism argued that the objectivity of causal and objective recognition is thought verified by experiments (practices). Classical mechanics argued that natural phenomena depend on the law of causality, while saying “when the position and velocity of a mass point at a given moment are known, the subsequent motion can be fully known”. Thermodynamics argued that cause and effect correspond to the phase difference between phenomena.

Law of Geared Causality (LAGEC)

As shown in FIGS. 5 to 10 and 12 to 13, one cause cannot generate one effect, and two or more causes generate two or more results (in geared cause) in terms of the principle of gear (POG). There are positive (+) and negative (−) in all things in the earth and universe. When positive (+) electricity collides with negative (−) electricity as the two causes, light and sound are generated as two results at the same time in terms of the principle of gear (POG). Since two or more causes always generate two or more effects in shapes of all things, the Law of geared causality (LAGC) is established. The distinction between cause and effect corresponds to the temporal and spatial order of incidents, and causes produce effects inductively and deductively. As shown in FIGS. 5 to 7 and 13, all things on Earth (cause and effect) and human thinking (information and judgment) arise and exist according to the Law of geared causality (LAGC). the argument that natural phenomena depend on the law of causality with saying “when the position and velocity of a mass point at a given moment are already known, the subsequent motion can be fully known”, and the argument of thermodynamics that cause and effect correspond to the phase difference between phenomena is the same as the argument that may be matched with the gear relationship of cause and effect since cause and effect are the temporal and spatial order of incidents. The argument that the relationship between cause and effect cannot be empirically derived by the law of causality and it is the product of human psychology that expects similar results from similar causes through repeated experience is the argument contrary to the order relationship between cause and effect and the relationship between cause and effect in the principle of gear (POG). The argument that the relation between cause and effect is a scientific and innate relationship under the precondition of experience and the argument of dialectical materialism verified by causal and consequential experiments (practices) is the order (deductive) relationship, which is the argument consistent with the inseparable inductive and deductive relationships in terms of the principle of gear (POG) of cause and effect.

Air Motion and Air Movement

In the atmospheric general circulation (AGC), in order to present mechanisms of tornado, hurricane, yellow dust, and typhoon as shown in FIGS. 5 to 15, airdrop, airlump, airclod, airzone-windzone, law of geared causality (LAGEC), both handed principle of air (BHPA), and geared principle of fluid (GPF) are cited. The planar rotation of air corresponds to the air motion, and the planar air motion shifted in the direction perpendicular to the plane of air motion corresponds to the air movement and becomes wind.

Aerodynamic Force (ADF)

The aerodynamic force (ADF) generates the air motion and the air movement as shown in FIG. 8. Wind power obtained when air moves due to solar energy acts like hydraulic movement according to changes in temperature and density. Reaction force, moment, and moment of couple generate the wind power as the aerodynamic force according to the principle of force synthesis. As shown in FIG. 9, the aerodynamic force (ADF) is three-dimensionally divided into the resistance as drag generated from a front of a coordinate axis, the up and down lift, and the left and right lateral force, in the front and rear, up and down, and left and right directions. The aerodynamic force is divided, around the coordinate axis, into a pitching moment of the drag and lift force, a rolling moment of the lift and lateral force, and a yawing moment, and the three forces and moments are called six component forces. The three component forces correspond to the drag force, lift force, and pitching moment that act in a longitudinal plane composed of front and rear axes and up and down axes, and there are wind tunnel tests of the six component forces and the three component forces.

Three Cells and Jet Stream

The Polar cell of polar easterlies and the Hadley cell of easterlies (trade wind) due to the vertical motion of air in two Earth Airbowls in the both hemispheres, generate polar jet stream (PJS) and subtropical jet stream (SJS) that rotate to the right through the gear action as shown in FIG. 10. In the South Hemisphere, Ferrel cell of westerlies generates polar jet stream (PJS) and subtropical jet stream (SJS) that rotate to the right through the gear action as shown in FIG. 12. The jet stream all are move from west to east according to the right handed principle of air (RHPA) of air as shown FIG. 9. Accordingly, as shown in FIGS. 10 to 12, 15, and 16, Polar Cell and Hadley Cell generate jet streams in the north hemisphere, Ferrel cell generates two jet streams in the south hemisphere, and polar easterlies, westerlies, and easterlies move east and west while rotating to the right by the three cells according to the both handed principle of air (BHPA).

The aerodrop is the smallest unit of air with surface force, body force, and density force for the spatial concept with respect to the air motion and movement. Air is classified into airdrop, airlump, airclod, and airzone. The air motion is a state in which aerodrops having a diameter of 0.2 mm move or rotate vertically and horizontally along with other air bubbles, and the air movement, which is wind, is a state in which aerodrops move vertically and horizontally. The three cells (Polar, Ferrel, and Hadley) as shown in FIGS. 10 and 12 correspond to the air motion.

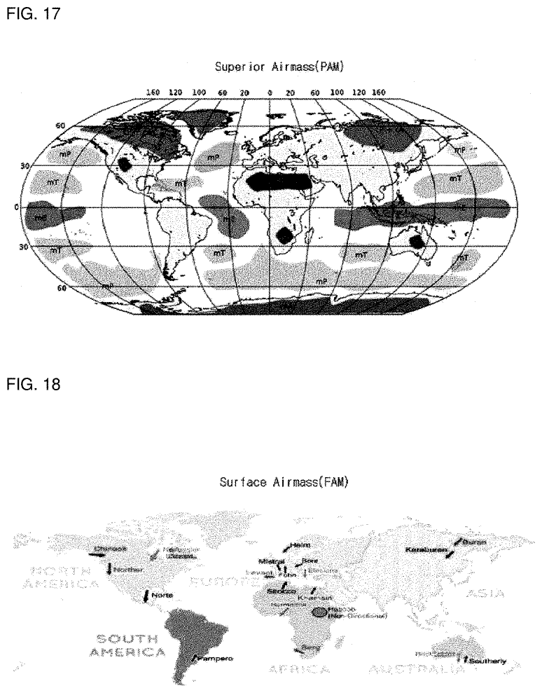

The airlump is a kind of small air mass having properties and density the same as the superior air mass (PAM) in FIG. 17 and the surface air mass (FAM) in FIG. 18. The airlump as a group of aerodrops serves as a basic unit of the air motion by the aerodynamic force (ADF) of FIG. 8.

The airclod is a small air mass having properties and density the same as the superior air mass (PAM) and the surface air mass (FAM) of FIGS. 17 and 18, and serves as a basic unit of the air movement. Two or more airclods of tornado, hurricane, yellow dust, and typhoon are present in each air mass, and move and rotate according to the principle of gear (POG). The airclod is an air movement moving in a circular manner like dustdevil for more than 10 minutes (600 seconds), and occurs at a speed of 0.1 m/s or more according to the Beaufort wind scale. The airclods move or shift together with the other airclods according to the principle of gear (POG) through the different aerodynamic forces (ADF) of FIG. 8.

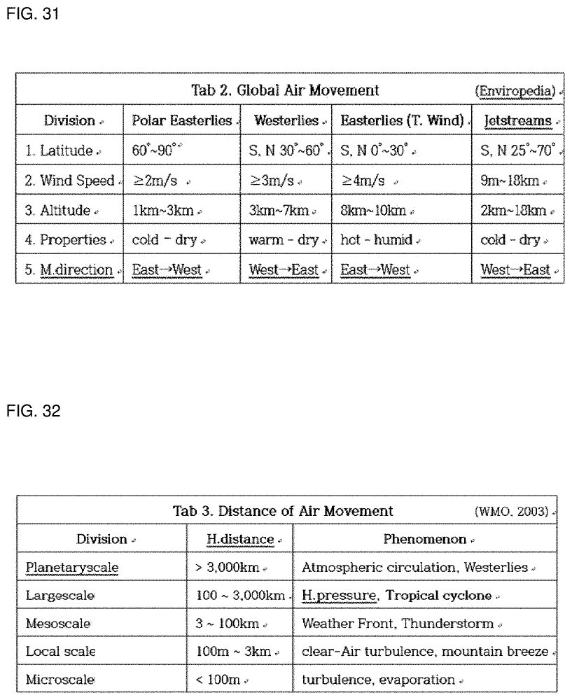

The air zone (wind zone) refers to a regional wind such as the surface layer current as shown in FIG. 22, and is subject to the classification of horizontal air movement as shown in FIGS. 31 and 32, unlike the classification of vertical air motion of Polar cell, Ferrel cell and Hadley cell of FIGS. 10, 12, 15, and 16. The air zone such as polar easterlies, westerlies, easterlies (trade winds), and jet streams move horizontally, and moves in the same way as the seawater circulation as shown in FIGS. 22, 31 and 32. Polar easterlies occur between latitudes 60° and 90° as shown in FIGS. 10, 11 and 31, westerlies occur between mid-latitudes 30° and 60°, and easterlies (trade wind) occur between latitudes 0° and 30° that is an equatorial region. Westerlies occurs at the top of easterlies according to the direction of the earth's rotation and the principal offender of gear (POG).

The earth airbowl is a bowl after removing the Earth from an air bowl of the troposphere like a ball in the action of air as shown in FIG. 14, and corresponds to a space between the Earth's surface and the tropopause in which convection occurs.

Vertical and Horizontal Actions of Air

Winds occur as a result of thermal imbalances according to latitudes. As shown in FIGS. 10 and 12, when the sun is directly positioned at the top Earth's surface receives most of the sun's radiant heat, and receives the greatest amount of solar radiant heat near the equator. About 50% of the solar radiant heat absorbed by the Earth's surface is used to evaporate water. The air near the equator is warm and contains a lot of water vapor. The air contains a lot of water vapor because the molecular weight of water vapor (H₂O) is 18 g·mol⁻¹ less than the molecular weight 28 g·mol⁻¹ of nitrogen (N₂) constituting the atmosphere. The air becomes lighter when containing the water vapor, and becomes relatively heavy when containing less water vapor. Since the air becomes lighter when heated and heavier when cooled, heated air may contain more water vapor. Since the air is a fluid, motion and movement may act simultaneously or only the motion may act separately.

Vertical and Horizontal Movements of Air

The Hadley circulation was published by Hadley in 1735, and refers to an atmospheric circulation according to the principle of gear (POG) that occurs directly due to thermal causes between latitudes 30° north and south from 0° of the equator as shown in FIGS. 10, 11, 12 and 15. The atmospheric circulation mainly consists of three circulation cells in each of the south and north hemispheres from the equator to the pole. The region from 0° of the equator to the latitude 30° is called Hadley cell. With regard to the atmospheric movement of Hadley cell, the Walker cell identified according to the longitudes is complexly acted with the Coriolis effect, so that the Walker cell becomes southwester in the north hemisphere and northwester in the south hemisphere when moving from the equator toward the poles, descends back to a lower altitude, and becomes northeaster in the north hemisphere and southeaster in the south hemisphere when moving toward the equator, thereby forming the trade winds. The region where air currents moving from the north and south hemispheres toward the equator meet again each other may be located slightly north of the equator because the north and south hemispheres have different land distribution and heat storage capacity.

In Ferrel cell, as shown in FIGS. 10, 11, 12 and 15, cool air from the poles descends and moves along the surface of the earth to the equatorm and the moving air meets air moving northward from the 30° latitude region at around 60° latitude and ascends again according to the principle of gear (POG). At this point, the ascending air partially moves toward the equator, and the rest move towards the poles, thereby forming a single cell between latitudes of 30° to 60°, which refers to the Ferrel cell. When a temperature distribution in a fluid is partially different, a warm downdraft occurs in the upper layer, and a cold updraft occurs in the lower layer. Some of the air descending from the mid-latitude high pressure zone to the ground are deflected to the right by the deflecting force when ascending to the polar-frontal zone in the 60° latitude region, and accordingly, westerlies occur on the ground.

In the polar cell, as shown in FIGS. 10, 11, 12 and 15, cool air from the poles descends and moves along the surface of the earth to the equator, and the moving air meets air moving northward from the 30° latitude region at around 60° latitude and ascends again according to the principle of gear (POG). At this point, the ascending air partially moves toward the equator, and the rest move towards the poles, thereby forming a cell between latitudes of 30° to 60°, which refers to the Polar cell. The air moving from the upper atmosphere to the pole among the air ascending from the polar-frontal zone descends while being cooled at the pole, thereby forming an extremely high pressure portion, and the air in the extremely high pressure portion, upon moving back along the surface to the polar-frontal zone, returns as the Polar easterlies under the influence of the deflecting force. As shown in FIGS. 10, 12, 15 and 32, each length of Hadley cell, Ferrel cell, and Pole cell are calculated to be 3,333 km (≈40,075 km÷12).

Jet stream is a strong air current moving horizontally and vertically in the upper troposphere and the stratosphere as shown in FIGS. 10, 11, 12, 15, 16 and 31, and has thousands of kilometers in length, hundreds of kilometers in width, and several kilometers in thickness as shown in FIGS. 31 and 32. Two jet streams are generated on the upper weather map at latitude 30° and mid-latitude 60°, in which the former is a subtropical jet stream (SJS) and the latter is a polar jet stream (PJS). The most important jet streams in the analysis of meteorological maps are the subtropical jet stream and the polar jet stream. The polar jet streams move through the mid-latitudes like flows of rivers, have the maximum wind speed of 100 m·s⁻¹ in winter, and sometimes surround the globe during peak winter season in the north hemisphere. The occurrence and location of mid-latitude cyclones are determined by the jet stream. Although an accurately prediction about the shape of the jet stream may be very helpful in forecasting the weather for more than a week, the prediction is impossible. Since the jet stream may have a region having a severe turbulence at a center portion thereof, it is necessary to carefully operate aircrafts. The polar jet stream (PJS) is an important characteristic of upper atmospheric circulation, and solar radiation energy is an energy source of the polar jet stream. The momentum and energy of the jet stream are related to the generation and maintenance of storms and circulations among smaller atmospheres. Changes in seasonal location and wind speed of the jet stream are related to the solar radiation energy on the ground. The temperature distribution of the ground is maintained to be matched with the jet stream, in which warm air is present in the south of a jet stream axis and cold air is present in the north thereof. In the north hemisphere, the polar jet stream (PJS) occurs at 35° north latitude in winter, and moves, in summer, to the north and occurs at 50° north latitude. The polar jet stream (PJS) is a jet stream that occurs in the upper layers of the polar-frontal zone, and occurs according to the horizontal pressure difference as a strong wind belt with narrow and strong air movements so as to serve as the axis of westerlies. The long wave of the jet stream generates a cyclonic curvature, and generates anticyclonic curvature in other regions. A large-scale cyclonic curvature in the jet stream may generate a large-scale mid-latitude cyclone, and in turn, the mid-latitude cyclone generates small-scale thunderclouds and tornadoes. The polar jet stream (PJS) occurs at different locations according to the season, in which the PJS moves north to 70° north latitude in summer and moves south to 30° north latitude in winter.

Polar easterlies move from east to west between latitudes 60° and 90° as shown in FIGS. 10, 12, 14, 15 and 31. Polar easterlies have the air motion that descends vertically from the pole and ascends vertically around 60° latitude, like the polar cell of FIG. 13.

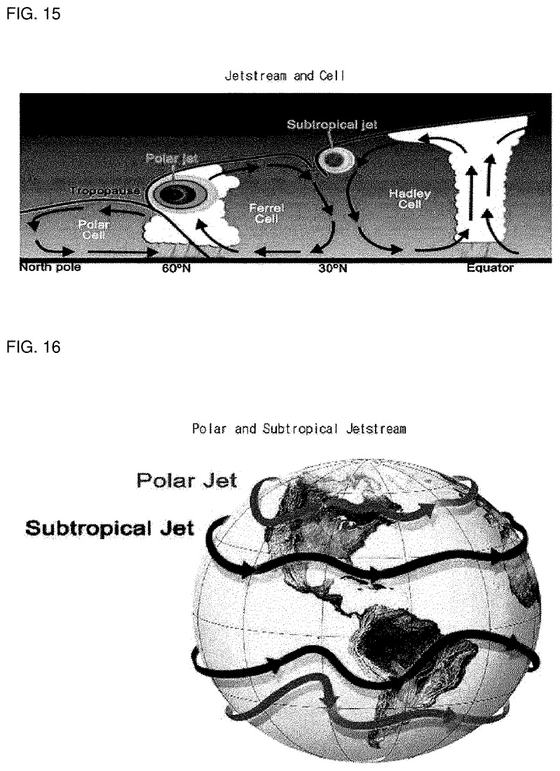

Westerlies move from west to east horizontally with the subtropical high pressure while being deflected between 30° and 60° latitudes as shown in FIGS. 10, 12, 14, 15 and 31. Westerlies have the air motion in which the wind moves vertically and shifts westward (air motion) like Ferrel cell of FIG. 15 between 30° and 60° latitudes.

Easterlies (trade winds) move from east to west as shown in FIGS. 10, 12, 14, 15 and 31. The air motion of the trade winds moves vertically and shifts eastward (air motion) like Hadley cell of FIG. 15 ascending at the equator and descending at 30° latitude.

Air Mass (AM)

The air mass (AM) is used conceptually to explain the causes of weather phenomena. The air mass (AM), as shown in FIGS. 17 and 18, is generated by receiving heat and water vapor from surfaces of the ground and sea water while air having uniform properties placed in the high pressure zone stays on the ground and sea for a long time, and is distinguished by temperature and humidity. The air mass is dry when occurring from the continent, is humid when occurring from the ocean, and has a high temperature when occurring from the low latitude. The surface air masses (FAM) are air masses that are strongly affected by the ground, and the superior air masses (PAM) are air masses that are not directly affected by the ground. The surface air masses (FAM) are classified according to the origin which is a region where the FAM occur, in which the air masses are classified according to the large-scale movement of the atmosphere. However, the superior air masses (PAM) are classified, regardless of the origin, based on the air temperature and water vapor content.

Superior Air Mass (PAM)

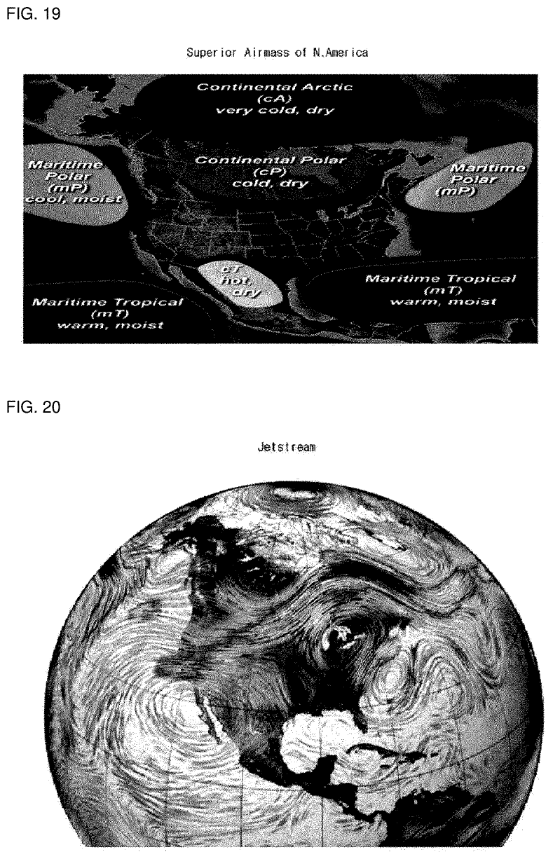

The arctic air mass (cA) and the Antarctic air mass (cAA) are cold, dry and stable as shown in FIGS. 17 and 19, and have properties similar to those of the maritime polar air mass (mP) in summer, but have a thin base layer and lose properties when moving south.

The continental polar air mass (cP) is cold, dry and stable as shown in FIGS. 17 and 19, and stable at the origin, but change in properties upon reaching the warm sea from the origin, so that snow falls on land.

The continental tropical air mass (cT) is warm, dry and stable as shown in FIGS. 17 and 19, and has a daily temperature changing large due to little water vapor. The occurrence regions are west of the Rocky Mountains in North America, 25° north latitude in northern Africa, 25° south latitude in southern Africa, and central Australia.

The maritime polar air mass (mP) is humid and unstable as shown in FIGS. 17 and 19, the occurrence regions are the Northeast and Northwest of the Pacific Ocean and the narrow northeast of the Atlantic Ocean in winter, the north sea region of 40° north latitude of the Pacific and Atlantic oceans in summer in the north hemisphere, and the south sea region of 50° south latitude of the Pacific, Atlantic, and Indian oceans in winter in the north hemisphere.

The maritime tropical air mass (mT) is warm and humid as shown in FIGS. 17 and 19 and slightly unstable near the ground, but dry and stable at high altitudes, in which anticyclone air masses at both sides of the Pacific Ocean and at the west of the Atlantic Ocean are unstable due to heavy downwelling and stable in the east.

The equatorial air mass (mE) is similar to the maritime tropical air mass (mT) as shown in FIGS. 17 and 19, but very unstable due to high temperature and humidity up to the upper layer. The equatorial air mass (mE) is the warm and humid air mass located near the equator, is distributed in the Pacific, Atlantic, and Indian Oceans, and belongs to the maritime air mass. The equatorial air mass is an air mass that contains a large amount of water vapor evaporated from the sea, and is hot and humid from the lower-middle layer to the upper layer of the troposphere. The equatorial air mass (mE) is an air mass that generates the tropical cyclone, rains heavily in Indonesia, the Pacific Ocean, the Indian Ocean, and mid and high latitude regions as monsoon and moves north together with typhoon. The equatorial air mass (mE) occurs in the ocean of 15° north latitude or below in summer and winter, with around 10° north latitude in summer in the north hemisphere, and around 10° south latitude in summer in the south hemisphere.

Surface Air Mass (FAM)

The surface air mass (FAM) is the local air mass (LAM) occurring under the influence of continents and oceans, and there are surface air masses such as surface layer currents (SLC) as shown in FIGS. 18 and 22.

Middle Air Mass (MAM) and Local Air Mass (LAM)

The middle air mass (MAM) is classified according to atmospheric pressure, located in a middle layer of the superior air mass (PAM) and the surface air mass (FAM), located between the superior air mass (PAM) and the superior air mass (PAM). influenced by the superior air mass (PAM) and the surface air mass (FAM), acted independently of the surface air masses (FAM) or acted together with the surface air mass (FAM), and related to the three cells, the polar easterlies, the westerlies, the easterlies (trade wind), and the jet stream. The local air mass (LAM) is a small surface air mass (FAM), and occurs rapidly depending on local climatic conditions, then disappears soon and joins the surface air mass (FAM).

Movement and Alteration of Air Mass

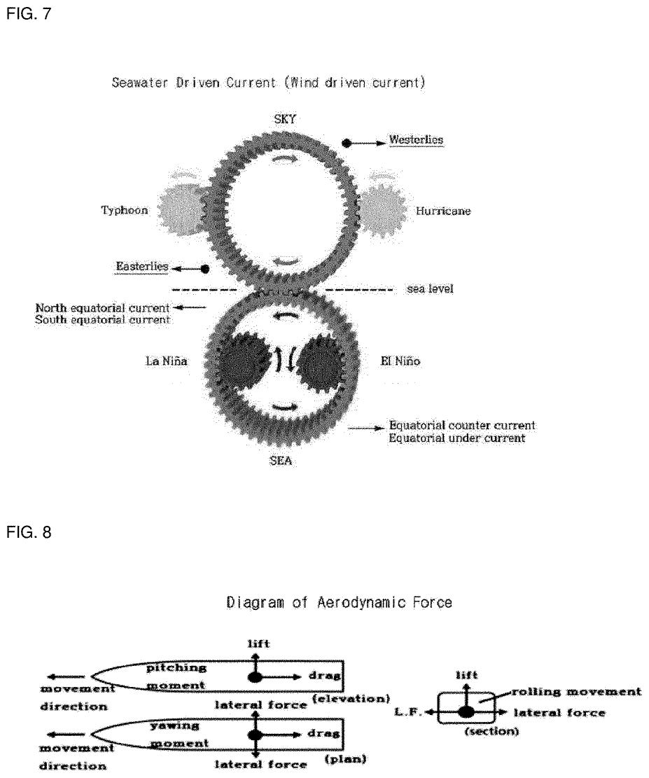

The warm air mass refers to an air mass having an air mass temperature higher than a ground temperature of the movement path, and the cold air mass is an air mass having an air mass temperature lower than the ground surface temperature of the movement path. When the air mass moves from the origin to a region subject to significantly different conditions, the air mass alteration occurs in which the air mass has properties significantly different from the unique properties of the air mass before the movement due to the influence of the ground or sea level of the movement path. Factors of the air mass alteration include a movement path of the air mass, a difference in properties of the ground, an elapsed time, and a movement speed as shown in FIGS. 7, 10, 11, 12, 14, 15 and 16. The important action of the air mass alteration is heating and cooling actions of the lower layer of the air mass.

Effects of Superior Air Mass (PAM) and Surface Air Mass (FAM)

As shown in 19 and 20, the superior air mass (PAM) includes two polar air masses (cA) and two continental polar air masses (cP) in the north of North America, the maritime polar air mass (mP) in the east, the continental tropical air mass (cT) in the west, and the maritime tropical air mass (mT) in the south, so tornadoes and hurricanes in North America occur under the influence of the surface air mass (FAM). Because, in the southeast region of Eurasia, there are Eurasia in the west, the maritime polar air mass (mP) in the north, the maritime tropical air mass (mT) in the east, and the equatorial air mass (mE) in the south, typhoons are caused by the influence of surface air mass (FAM), and yellow dust occurs in the center of Eurasia. In the Indian Ocean, due to the influence of the equatorial air masses (mE) and the surface air masses (FAM), monsoons and cyclones occur in the eastern and western regions of the Indian Peninsula.

Hurricane's airclod (HAC) and typhoon's airclod (TAC) are airclods generated, regardless of the subtropical jet stream (SJS), with the action of worm gear as shown in FIGS. 5 to 7 of the tropical air mass and easterlies, and occur in the Atlantic Ocean of North America and the Western Pacific Ocean of Southeast Asia.

The tornado's airclod (TAC) is an airclod generated with the action of worm gear as shown in FIGS. 5 to 7 of the continental air mass, maritime air mass, polar jet stream (PJS), and westerlies, and occurs in central North America, southern South America, northwestern Europe, Australia, and northern and southern Africa.

Oceanic General Circulation (OGC)

In order to prove the mechanisms of tornado, yellow dust, hurricane, typhoon, El Niño, and La Niña as shown in FIGS. 5 to 7 according to the principle of gear (POG), Torricelli theorem (TOT), principle of Pascal (PAP), butterfly effect (BUFE), law of geared causality (LAGC), the seawater driven circulation (SDC) and the extra geared current (EGC) are cited.

Interaction of Air and Seawater

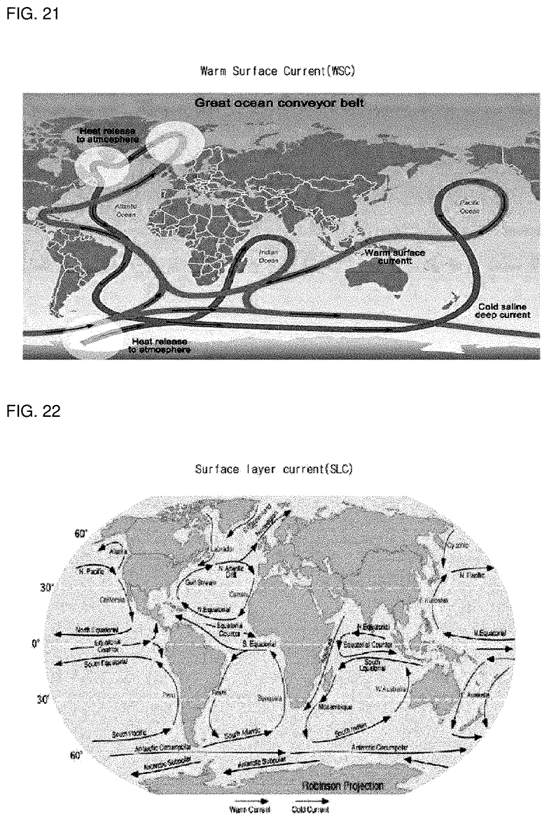

The surface area of the Earth is 513 million km² as shown in FIGS. 21 and 22, and the area of sea is 364 million km² and the area of land is 149 million km². Accordingly, the proportions of sea and land are 71% and 29%, and the density of seawater to air is 841 times (≈1,030÷1.225). Thus, the impact of the sea on the earth and the impact of the movement of seawater on the movement of air are significant. The impact of the seawater driven circulation (SDC) may be large and the impact of the wind driven circulation (WDC) may be small. The current force (CRF) for moving seawater includes a temperature force and a density force that cause vertical motion of seawater as a force caused by seawater itself, and includes a stress of air movement acting on the sea surface. It is said that the aerodynamic force (ADF) supplies main energy to the movement of the surface layer current (SLC) as shown in FIGS. 7, 8, 9 and 22, however, the warm surface current (WSC) generates heat when sinking as shown in FIG. 21 and when intersecting with the surface layer current (SLC) so as to provide the main energy for the motion and movement of air. The air circulation and seawater circulation are generated by the aerodynamic force (ADF) and the current force (CRF) that directly interchange solar energy as shown in FIG. 7, respectively. The seawater circulation is affected by the air circulation. However, since the air temperature rises by 7° C. or higher when the seawater temperature rises by 1° C. as shown in FIG. 7, the current force (CRF) has an effect on the air circulation with the jet stream as shown in FIGS. 5, 6, 7, 10, 11, 12, 15, 16, 21 and 22.

Wind Driven Circulation (WDC) and Seawater Driven Circulation (SDC)

The movement direction of the ocean current is determined as shown in FIGS. 7, 14, 21, 22, 23 and 24 by the wind driven circulation (WDC) performing the action of gear according to the principle of gear (POG), the air temperature rises as the temperature of seawater rises due to solar energy, and shower clouds are generated when hot and humid air rises. As the shower clouds increases, the air becomes unstable, and low pressure causes thunderstorms and tornadoes. Together with the wind driven circulation (WDC) of air as shown in FIGS. 7, 14, 21, 22, 23 and 24, the oceanic general circulation (OGC), heat generation, upwelling, and downwelling, and the seawater driven circulation (SDC) as shown in FIGS. 7, 14, 21, 22, 23, and 24 cause hurricanes, typhoons, El Niños and La Niñas, and also cause other extreme weather events. The wind driven circulation (WDC) and the seawater driven circulation (SDC) occur together. Since the ratio of seawater density to air density is 841 times (≈1,030÷1.225), the surface layer current (WSC) of FIG. 21 and the surface layer current (SLC) of FIG. 22 significantly increase the temperature of the upper layer air by 50% of solar energy. Contrary to the surface layer current (WSC), the surface layer current (SLC) rotates while moving in the movement direction of the seawater according to the seawater driven circulation (SDC) of the principle of gear (POG) as shown in FIG. 7 occurring in the same direction as the movement direction of the surface layer current (SLC).

Circulation of Deep Layer Seawater

As shown in FIG. 21, horizontal and vertical movements of deep layer seawater occurring in the Arctic and Antarctic Oceans is called a deep layer current (DLC), and the deep layer current is classified into middle laminar currents, deep laminar currents and low laminar currents, and supplies oxygen while distributing energy to each latitude. Since the density of seawater is determined by the temperature and salinity of the seawater, the seawater circulation due to the density difference includes a Thermohaline circulation (THLC) as shown in FIG. 21.

Antarctic deep water is generated from Antarctic bottom water in the Weddell Sea in Antarctica, and moves to the north of the Pacific, Atlantic, and Indian Oceans as shown in FIG. 21.

In the Atlantic deep water, the influence of density determined by salinity and water temperature occurs as shown in FIG. 21 in Mediterranean seawater moving to the Atlantic Ocean. As the cold and heavy water mass (WM), which is cooled down in the Greenland waters of the Norwegian Sea and has the water temperature dropped below 0° C., sinks down, and accordingly, North Atlantic Deep Water moving into the Atlantic Ocean may fill the deep layer of the Atlantic Ocean and move to the Pacific Ocean.

Pacific deep water is deep seawater in Greenland located in the north of the North Atlantic Ocean, and moves back to Greenland through the Pacific Ocean. The polar bottom water sunken as shown in FIG. 21 moves to the bottom of the Aleutian Islands at 50° north latitude in the Pacific Ocean and upwells. Australia and New Zealand are sometimes also affected by upwelling of the North Atlantic deep water.

Indian deep water is deep seawater in Greenland placed in the north of the North Atlantic Ocean, and moves back to Greenland via the Indian Ocean as shown in FIG. 21. The sunken polar bottom water mainly upwells in the Indian Ocean.

Circulation of Warm Surface Current

As shown in FIG. 21, the length of the warm surface current (WSC) is 113,000 km. Accordingly, when assumed that the depth and width are 200 m and 5 km, respectively, the total amount of warm surface current (WSC) is 113,000 km³ (=0.2 km×5 km×113,000 km). Since the North Atlantic Ocean is the source of deep layer seawater, and the warm surface current (WSC) of the North Atlantic generates maximum heat in the southeastern region of North America, tornadoes and hurricanes occur frequently in great scales, and the occurrence magnitude is also gradually increasing. The warm surface current (WSC) is affected by solar energy (50%) together with the surface layer current (SLC).

Heat of Deep Layer Current (DLC) and Warm Surface Current (WSC)

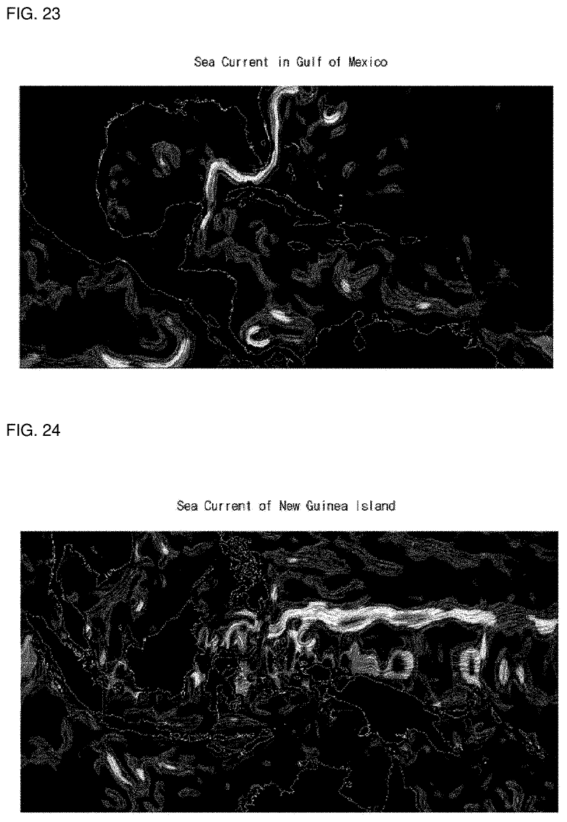

As shown in FIGS. 7 and 21, the warm surface current (WSC) generated by upwelling of the deep layer current (DLC) moving horizontally and vertically generates heat. The deep layer current (DLC) and the warm surface current (WSC) supply oxygen while distributing energy between high and low latitudes. Since the density of seawater is determined by the temperature and salinity of the seawater, the thermohaline circulation (THLC) occurs due to the difference in seawater density. As shown in FIG. 21, the Atlantic oceanic deep water (ADW) generates significant heat as shown in FIGS. 23, 25 and 26 upon downwelling in the Greenland Sea, upon rotation in the Labrador Sea in the North Atlantic, upon intersection with the Gulf Stream of Mexico in the Sargasso Sea of the Atlantic Ocean as shown in FIGS. 23 to 26, upon intersection with the North Equatorial Current in the equatorial region of the Atlantic Ocean, and upon passing through the Florida Peninsula. As shown in FIGS. 7 and 21, Indian oceanic deep seawater (IDW) moves to the South Atlantic Ocean while rotating to the right and upwelling, and generates heat while intersecting with the Agulhas current when passing through the southern end of South Africa. The warm surface current (WSC) generates heat when sinking (downwelling) and when intersecting with deep layer current (DLC) in the Pacific and Atlantic oceans. Pacific oceanic deep seawater (PDW) upwells at 50° north latitude where the Aleutian Islands in the North Pacific are located, generates heat when intersecting with the warm surface current (WSC) and the North Equatorial Current (NEC), and generates heat when passing through New Guinea Island after upwelling as shown in FIGS. 7, 21, 24 and 28. The heat of the warm surface current (WSC) is energy of generating hurricanes, typhoons, and tornadoes.

Surface Layer Current Circulation and Wind Driven Circulation (WDC)

The circulation of surface layer current as shown in FIGS. 7 and 22 is closely related to atmospheric circulation, and seawater circulates along the wind driven circulation (WDC) moving in the wind direction due to the wind stress acting on the sea level. Accordingly, the movement of seawater by wind extends to a depth of 50 m. An ‘Ekman layer’ refers to the depth up to 50 m. By the balance of the wind stress, Coriolis force, and the friction force, the surface layer current (SLC) moves to the right in the Northern hemisphere at an angle of 45° with respect to the wind direction, and moves to the left in the Southern hemisphere. As the seawater depth is greater in the Ekman layer, the flow rate of the seawater gradually decreases, the seawater is gradually directed to the right along the spiral, and the direction is reversed at depths where the flow rate of seawater reaches 4.35% of the surface layer seawater. The movement of seawater in the Ekman layer occurs to the right at 90° to the wind direction in the Northern hemisphere, and occurs to the left in the Southern hemisphere. As shown in FIG. 21, the upwelling and downwelling also occur in a region where wind run parallel to the shoreline. Representative upwelling sea zones include the Peruvian coast of South America and the northwest coast of Africa. The eastern boundary of the subtropical sea is also included in the upwelling sea zone. The deep water cold and containing a lot of nutrient salt rises to the surface layer due to the upwelling, thereby creating a marine environment rich in biological productivity.

Equatorial currents (EC) move from east to west by easterlies in the equatorial sea zone at 5° north latitude as shown in FIGS. 7, 21 and 22. The Equatorial Undercurrent (EUC), in which seawater accumulated due to the movement of the surface layer current strongly moves eastward from the bottom of the equatorial current, moves strongly eastward in a depth of about 100 meters at a speed of 1 m/s or more in the opposite direction of the Equatorial Current (EC). The North Equatorial Current (NEC) as the equatorial current (EC) moves in the northern hemisphere of the equatorial convergence zone, and the South Equatorial Current (SEC) as the Equatorial Current (EC) moves in the southern hemisphere. As shown in FIGS. 7, 21 and 22, the El Niño phenomenon, in which the western water temperature and sea level descend while the eastern sea level ascends in the Pacific Ocean, is a phenomenon that is currently receiving a lot of attention in conjunction with climate change that occurs on a global scale.

The subtropical gyre (TG) occurs in the aspect of high pressure circulation as shown in FIGS. 7, 21 and 22, and the subtropical convergence zone occurs at around 20° to 30° latitude by Ekman transport. The center of the subtropical convergence zone is biased to the west of the ocean. The western center of the subtropical convergence zone causes the Western boundary current strongly moving toward high latitudes along the western boundary of the ocean, and the strong movement of up to 2 m to 3 m per second transports the remaining thermal energy from low latitudes to high latitudes, thereby exerting significant impact on the Earth's climate.

The subpolar gyre (PG) represents a low pressure circulation as shown in FIGS. 7, 21 and 22, and upwelling water and surface layer water occur inside the gyre due to the low pressure. The subpolar gyre is unclear in the southern hemisphere. The Weddell gyre, which generates a huge circulatory flow between the Antarctic circulatory current and Antarctica, occurs frequently in the subpolar gyre in the northern hemisphere, and another low pressure circulatory flow also occurs in the north of the Ross Sea.

Antarctic circumpolar current (AC), as shown in FIGS. 7, 21 and 22, is a strong circulating current moving from west to east while surrounding Antarctica along a band of 50° to 60° south latitude. The Antarctic circumpolar current (AC) transports about 125 million cubic meters of seawater per second throughout a distance of about 24,000 kilometers.

Equatorial Counter Current (ECC) and Equatorial Under Current (EUC)

Equatorial counter current (ECC), as shown in FIGS. 7, 21 and 22, occurs between 3° and 10° north latitudes of the Atlantic, Pacific, and Indian Oceans, and moves south during winter and north during summer in the northern hemisphere. The sea level rises in the west because easterlies push the seawater to the equatorial current. The high western sea level moves eastward along the slope in equatorial doldrums having no air movement. As shown in FIGS. 7 and 22, the equatorial counter current (ECC) in the Pacific is strong, the equatorial counter current in the Atlantic Ocean is strong at the coast of Guinea in Africa, and the equatorial counter current in the Indian Ocean moves only south of the equator during winter. The equatorial counter current (ECC) provides the cause of hurricanes and typhoons in the Northern hemisphere, and causes El Niño and La Niña. The equatorial under current (EUC) moves to the east under the equatorial current (EC).

Northern Equatorial Current (NEC)

The north equatorial current (NEC) is the equatorial current (EC) like the south equatorial current (SEC), moves from east to west in the Northern hemisphere as shown in FIGS. 7 and 22, occurs by the northeast trade winds, and serves as an important factor in the oceanic circulation as a part of the subtropical circulation. The north equatorial current (NEC) moves in the continental wind belt between 8° and 23° north latitude in the Pacific and Atlantic oceans, moves from 0° to 10° north latitude in the Indian Ocean, and occurs only in winter without occurring in summer when the southwest monsoon is strong. The north equatorial current (NEC) in the Pacific Ocean is caused by the merging of the equatorial counter current (ECC) and the California current as shown in FIG. 21. The northern equatorial current splits in two directions from the east of the Philippines, in which some move north to form the Kuroshio Current, and the remainder moves south and becomes the equatorial counter current (ECC). The north equatorial current (NEC) has a strong southward force in winter, thereby moving south to the north of New Guinea Island and moving to the southern hemisphere as shown in FIG. 22. In the north equatorial current (NEC) in the Atlantic Ocean, the Canary Current moves westward and splits into two directions, so as to be connected to the Anchir Current in the Anchir Islands and the Florida Current. The north equatorial current (NEC) joins the equatorial counter current (ECC), thereby providing the cause of the occurrence of tornadoes as shown in FIGS. 5 to 7, and generating El Niño and La Niña.

Southern Equatorial Current (SEC)

The south equatorial current (SEC) is a subtropical circulation in the southern hemisphere ocean as shown in FIGS. 7 and 22, and the easterlies are asymmetric with respect to the equator, and accordingly, some move to the lower latitudes of the northern hemisphere without existing in the southern hemisphere, and move at 3° north latitude and 20° south latitude in the Pacific and Atlantic Oceans. The south equatorial current (SEC) in the Pacific Ocean is connected to the East Australian Current, the West Wind Drifts, and the Peru Current. In the Atlantic Ocean, some of the southern equatorial current (SEC) move north to the northeast of Brazil and move to the Caribbean Sea, thereby forming the Gulf Current and the Florida Current together with the northern equatorial current (NEC), and some move south to the east coast of Brazil, thereby forming the Brazilian Current. The southern equatorial current (SEC) provides the cause of tornadoes and hurricanes as shown in FIGS. 5 to 7, and causes El Niño and La Niña.

Principle of Gear of Surface Layer Current (SLC) and Wind Driven Circulation (WDC)

The surface layer current (SLC) of FIG. 22 may not circulate in the direction of air movement due to the stress of air movement according to the wind driven circulation (WDC) of FIG. 7, and rotates in the opposite direction with the gear action as shown in FIGS. 7 and 22, thereby generating heat while moving to the right in the northern hemisphere and moving to the left in the southern hemisphere, and accordingly, raising the temperature of the upper air. As shown in FIGS. 7 and 22, the equatorial counter current (ECC) and the equatorial under current (EUC) move from west to east, and the north equatorial current (NEC) and the south equatorial current (SEC) move from east to west, thereby rotating counterclockwise according to the principle of gear (POG) of FIG. 7. The north equatorial current (NEC) in the Pacific and Atlantic Oceans moves westward from the north of the equatorial convergence zone, and the southern equatorial current (SEC) of the Pacific and Atlantic Oceans moves eastward in the southern hemisphere, thereby generating heat. The subtropical gyres (TGn, TGs) occur according to the high pressure circulation as shown in FIGS. 7, 21 and 22, the submaximal gyres (PGn, PGs) generate the low pressure circulation, and upwelling water and surface layer water occur inside the gyre due to the low pressure.

Heat Generation of Surface Layer current (SLC)

In regard to the seawater structure as shown in FIGS. 7 and 22, since the depth of hot water layer is deep in the west of the tropical Pacific (TP) and shallow in the east of the tropical Pacific (TP), the hot water zone is deep in the west and shallow in the east. Due to the separation of low-temperature deep seawater layer caused by the shallow thermocline layer, and the east-west difference in the average temperature of surface layer seawater, the sea level in the west is higher than in the east. A lot of precipitation occurs in Indonesia and the western region of the Equatorial Pacific (EP), and there is less precipitation in the east of the Equatorial Pacific (EP). The average pattern of regional precipitation and westerlies and easterlies, rotates clockwise as shown in FIG. 7 according to the principle of gear (POG) from east to west along the easterlies of the lower layer and westerlies of the upper layer. La Niña in the tropical Pacific (TP) is a phenomenon in which easterlies of the lower atmosphere and westerlies of the upper atmosphere are strengthened in the eastern Pacific. Due to the rotation clockwise as shown in FIG. 7 according to the gear action of the wind driven circulation (WDC) and the seawater driven circulation (SDC) that are large-scale movements of air in the east-west directions, the heat is generated in a large-scale in the west of the Pacific Ocean. The seawater movement causing El Niño and La Niña in the tropical Pacific (TP) is the same as the movements of the equatorial current (EC), the equatorial counter current (ECC) and the equatorial under current (EUC) on the equator which rotate counterclockwise in contrast to the air rotation of the tropical Pacific (TP) as shown in FIGS. 7, 10, 12 and 14. As shown in FIG. 21, the surface layer current (SLC) generates a geared current (GCR) in the opposite direction according to the principle of gear (POG) and the geared principle of fluid (GPF) of FIG. 7 with the seawater driven circulation (SDC), and geared current (GCR) disappears as soon as the gear action of the surface layer current (SLC) is finished. The southern equatorial current (SEC), north equatorial current (NEC), equatorial counter current (ECC), equatorial undercurrent (EUC), and warm surface current (WSC) generate heat when moving as shown in FIG. 7, and supply heat energy to the upper air to generate the local air mass (LAM) and the local airclod (LAC). As shown in FIGS. 21 and 22, heat is generated upon circulation of the warm surface current (WSC) and the surface layer current (SLC) and upon downwelling into the deep layer current (DLC). As shown in FIGS. 5 to 7, the heat generation of the warm surface current (WSC), the southern equatorial current (SEC), the north equatorial current (NEC), the equatorial undercurrent (EUC), and the equatorial counter current (ECC) provides energy of generating hurricanes, typhoons, tornadoes, El Niño, and La Niña.

The undersea tunnel according to the disclosed embodiment is used to reduce or prevent natural disasters including typhoons and hurricanes caused by the difference in water temperature between two sides when ocean currents are blocked by the peninsula or island.

For example, the undersea tunnel may be arranged in the form of passing through a peninsula or an island to allow the seawater at both sides of the peninsula or island to communicate, thereby reducing the difference in temperatures between the both sides, so as to be used to distribute or weaken the energy generated by hurricanes, typhoons and tornadoes.

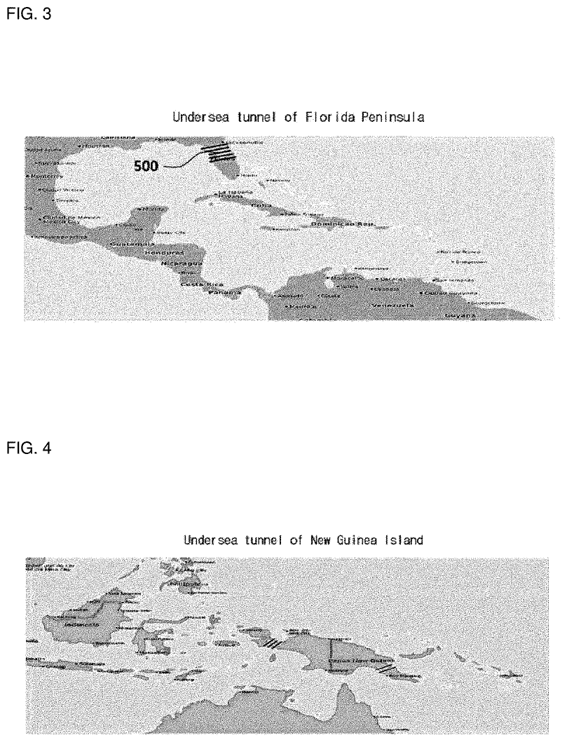

For example, undersea tunnels may be arranged to connect both sides of the peninsula shown in FIG. 3 and the island shown in FIG. 4. The specific configuration thereof will be described later.

Seawater Driven Circulation (SDC) and Heat Energy

In regard to the seawater structure, since the depth of hot water layer is deep in the west of the tropical Pacific (TP) and shallow in the east of the tropical Pacific (TP), the hot water zone is deep in the west and shallow in the east. Due to the separation of low-temperature deep seawater layer caused by the shallow thermocline layer, and due to the east-west difference in the average temperature of surface layer seawater, the sea level in the west is higher than in the east. Under normal conditions, a lot of precipitation occurs in Indonesia and the western region of the Equatorial Pacific (EP), and there is less precipitation in the east of the Equatorial Pacific (EP). In the reciprocal pattern of seawater temperature and local precipitation, as shown FIGS. 7 and 21, the upper layer westerlies rotate counterclockwise from west to east, and the lower layer easterlies rotate clockwise from east to west in the tropical Pacific (TP). La Niña is a phenomenon in which easterlies of the lower atmosphere and westerlies of the upper atmosphere are strengthened in the eastern Pacific, and is a large-scale east-west movement of air in the tropical Pacific (TP). The wind driven circulation (WDC) and the seawater driven circulation (SDC) as shown in FIG. 7 are important. The currents that generate El Niño and La Niña in the tropical Pacific (TP) and equatorial Pacific (EP) include, as shown in FIGS. 7, 21 and 22, the warm surface current (WSC) and the equatorial counter current (ECC) and equatorial undercurrent (EUC) rotating counterclockwise, and include the north equatorial current (NEC) and the south equatorial current (SEC) rotating counterclockwise. The circulation and friction of the warm surface current (WSC), the southern equatorial current (SEC), the north equatorial current (NEC), the equatorial counter current (ECC), and the equatorial undercurrent (EUC) with the seawater driven circulation (SDC) as shown in FIG. 7, introduce the easterlies and the tropical cyclone as shown in FIG. 7, thereby supplying or generating the energy of generating tornadoes, hurricanes, typhoons, El Niño, and La Niña as shown FIGS. 5, 6 and 7. According to the seawater driven circulation (SDC) due to the solar energy, the warm surface current (WSC), the north equatorial current (NEC), the southern equatorial current (SEC), the equatorial counter current (ECC), and the equatorial undercurrent (EUC) are circulated, thereby generating heat when being intersected with each other as shown in FIGS. 21 and 22, and the generated heat causes tornadoes, hurricanes, and typhoons together with the wind driven circulation (WDC) as shown in FIGS. 5, 6, and 7. As shown in FIGS. 7, 21, 23, 25 and 26, the warm surface current (WSC) stagnates in the Florida Peninsula of North America and generates maximum heat, and as shown in FIGS. 7, 21, 24, 25 and 28, stagnates in the island of New Guinea of Southeast Asia and generates maximum heat, and the generated heat supplies the energy of generating tornadoes, hurricanes, and typhoons as shown in FIGS. 5 to 7.

Florida Peninsula and Seawater driven Circulation (SDC)

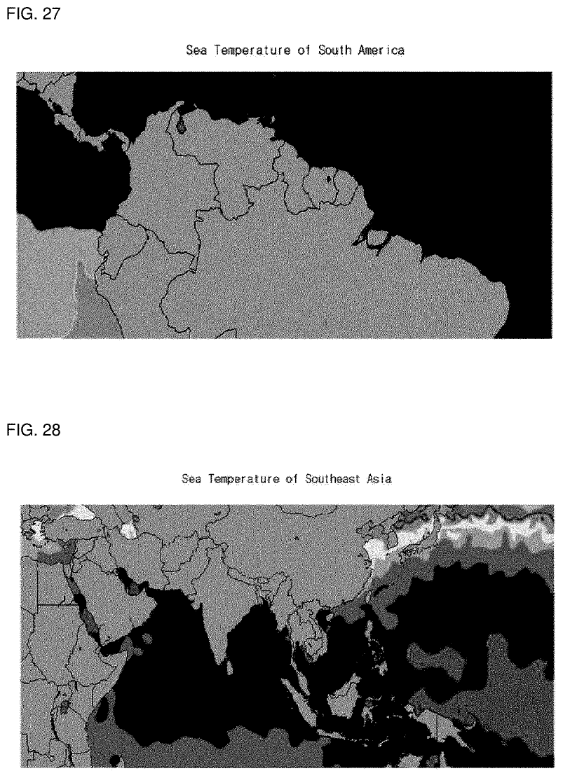

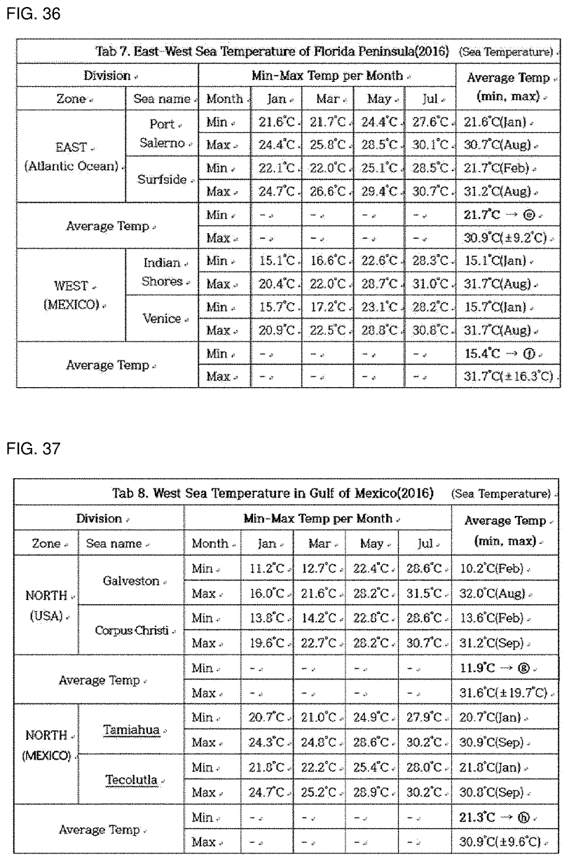

As shown in FIGS. 7, 19, 20, 23, 25, 26 and 27, the Florida Peninsula disrupts the seawater driven circulation (SDC), such as movements of the Mexico stream, as shown in FIG. 7 of the warm surface current (WSC), the north equatorial current (NEC) and the south equatorial current (SEC), thereby causing stagnation and heat, and the generated heat continuously generates the high-temperature and high-humidity low pressure in the Caribbean Sea, thereby supplying the energy of generating hurricanes as shown in FIGS. 5 to 7, and supplying minor causes of El Niño and La Niña. As shown in FIG. 36, the temperature difference between the east and west of the Florida Peninsula is 6.3° C. (=21.7° C.−15.4° C.). In FIGS. 36 and 37, the temperature difference between the east and west of the Gulf of Mexico is 3.5° C. (=15.4° C.−11.9° C.). In FIG. 37, since the temperature difference between the north and south in the western Gulf of Mexico is 9.4° C. (=21.3° C.−11.9° C.), the Florida peninsula continuously generates the low pressure inside the Gulf of Mexico such as Sealake as shown in FIGS. 21, 22, 23, 25, 26 and 27, to supply the energy of generating tornadoes together with the Gulf of Mexico as shown in FIGS. 5 to 7, thereby supplying small causes of El Niño and La Niña.

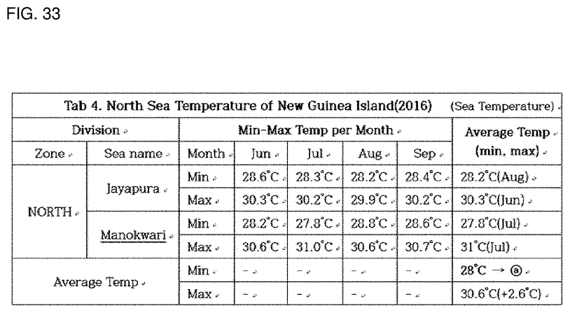

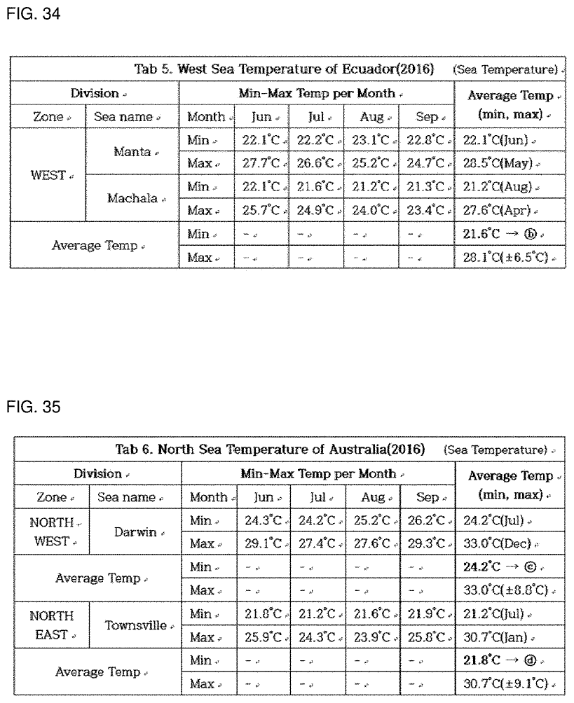

New Guinea Island and Seawater Driven Circulation (SDC) The New Guinea Island interferes with the movement of the warm surface current (WSC) as shown in FIGS. 21, 22, 24, 25 and 28, thereby generating the high-temperature and high-humidity low pressure in the northern New Guinea Island to supply the energy of generating typhoons as shown in FIGS. 5 to 7. Since the average low-temperature seawater temperature difference between the New Guinea Island and Ecuador on the same latitude is 6.4° C. (=28° C.−21.6° C.) as shown in FIGS. 33 and 34, and the difference in seawater temperature between the east and west at the same latitude in Australia is 2.4° C. (=24.2° C.−21.8° C.) as shown in FIG. 35, it is proven that the heat generation of collision and stagnation is happening due to the seawater driven circulation (SDC) as shown in FIG. 7 of the warm surface current (WSC), the equatorial counter current (ECC), the equatorial undercurrent (EUC), the north equatorial current (NEC), and the southern equatorial current (SEC) in New Guinea Island as shown in FIGS. 21, 22, 24, 25 and 28.

Energy of Generating El Niño and La Niña in Pacific Ocean

It is said that El Niño and La Niña generated by the wind driven circulation (WDC) as shown in FIG. 7. However, the southern oscillation (SO) of El Niño and La Niña occurs, when the sea water temperature changes greatly due to the wind driven circulation (WDC) and the seawater driven circulation (SDC) as shown in FIG. 7, and when there is abnormality in the clockwise circulation in which the equatorial counter current (ECC) and the equatorial undercurrent (EUC) move from west to east, and the north equatorial current (NEC) and the south equatorial current (SEC) move from east to west as shown in FIG. 7.

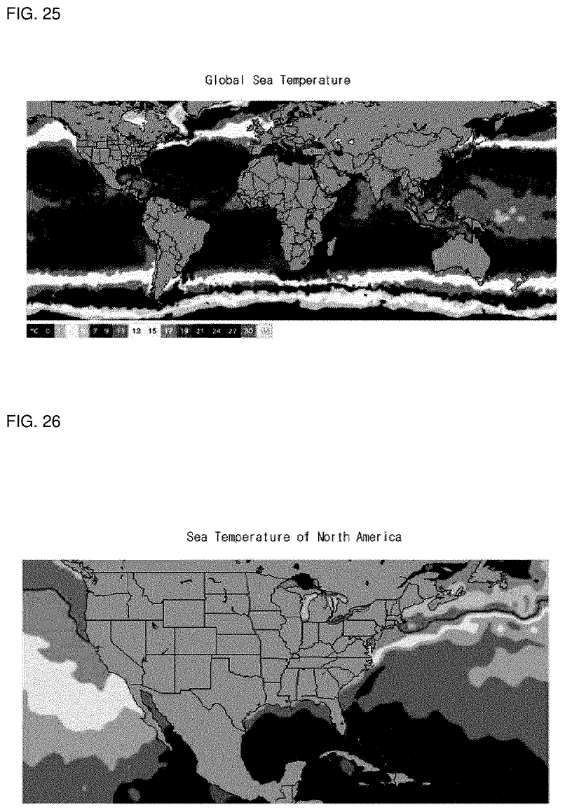

El Niño is an abnormal phenomenon in which easterlies (trade winds) are weakened, and accordingly, the sea water temperature near the equator of the eastern Pacific is 0.5° C. higher than the normal year for several months or more as shown in FIGS. 7, 21 and 22. When the warm seawater in the eastern Pacific moves westward according to the seawater driven circulation (SDC) as shown in FIG. 7, the warm seawater in the western Pacific vaporizes into water vapor, thereby generating clouds and low pressure. El Niño occurs as shown in FIG. 7 as the high-temperature water phenomenon in which the high pressure in the Indian Ocean is introduced into the generated low pressure to weaken easterlies in the western Pacific, and accordingly, the seawater has a temperature of 0.5° C. higher or more than the normal year for several months or more as shown in FIGS. 25, 27 and 28. The difference between the minimum seawater temperature in the New Guinea Island and the coast of Ecuador at the same latitude is calculated as 6.4° C. (=28° C.−21.6° C.) as shown in FIGS. 33 and 34. Due to the increase in seawater temperature along the coast of Ecuador, the decrease in nutrients and the decrease in dissolved oxygen generate water vapor to raise the temperature of air, thereby the low pressure is generated as shown in FIGS. 5 to 7, and the ascending water vapor and low pressure air create many clouds.

La Niña is an abnormal phenomenon in which easterlies are strengthened, and accordingly, the sea water temperature in the equator region of the eastern Pacific is 0.5° C. higher than the normal year for several months or more as shown in FIGS. 7, 21 and 22, occurs contrary to El Niño, and may occur after El Niño occurs. La Niña occurs when the easterlies in the equator become stronger than the normal year due to the wind driven circulation (WDC) as shown in FIG. 7, or when the seawater temperature in the western Pacific rises from the normal year, the low-temperature seawater upwells, and accordingly the low-temperature phenomenon continues in the eastern Pacific of the equator due to the seawater driven circulation (SDC) as shown in FIG. 7. As shown in FIGS. 5 to 7, precipitation increases in Indonesia, the Philippines and Australia having the strong low pressure, thereby causing flooding. Whereas, droughts occur in Peru and Chile having the strong high pressure, thereby causing cold waves and heavy snowfalls in North America.

Typhoon

As shown in FIGS. 5, 6, 7, 14, 21 and 22 according to the seawater driven circulation (SDC), the warm surface current (WSC), the north equatorial current (NEC), the southern equatorial current (SEC), the equatorial counter current (ECC), and the equatorial undercurrent (EUC) receive resistance from the New Guinea Island to heat the air, thereby generating a lot of water vapor, and creating or expanding cyclones in the 5° to 25° north latitude to introduce the local air mass (LAM) and the local airclod (LAC) of the strong tropical cyclones and easterlies, thereby supplying the energy of generating typhoons.

Energy of Generating El Niño and La Niña in the Atlantic Ocean

In the New Guinea Island in the Pacific, the stagnation of the warm surface current (WSC), the north equatorial current (NEC), the southern equatorial current (SEC), the equatorial counter current (ECC), and the equatorial undercurrent (EUC) cause El Niño and La Niña), and supply even the causes of typhoons. As shown in FIGS. 7, 21, 22, 23, 25, 26 and 27, small extreme weather events such as the causes of El Niño and La Niña occur frequently in a small scale inside the Gulf of Mexico in the Atlantic Ocean and between the Caribbean Sea and the Gulf of Mexico. Thus, the small-scale and continuous occurrences of El Niño and La Niña continuously supply the energy of generating tornadoes and hurricanes as shown in FIG. 7. Since the warm surface current (WSC), the north equatorial current (NEC) and the southern equatorial current (SEC) are stagnant by the Gulf of Mexico and the Florida Peninsula, the meteorological phenomena such as small causes of El Niño and La Niña occur north and south to the Caribbean Sea like the direction of the warm surface current (FIG. 21), and occur east and west in the Gulf of Mexico.

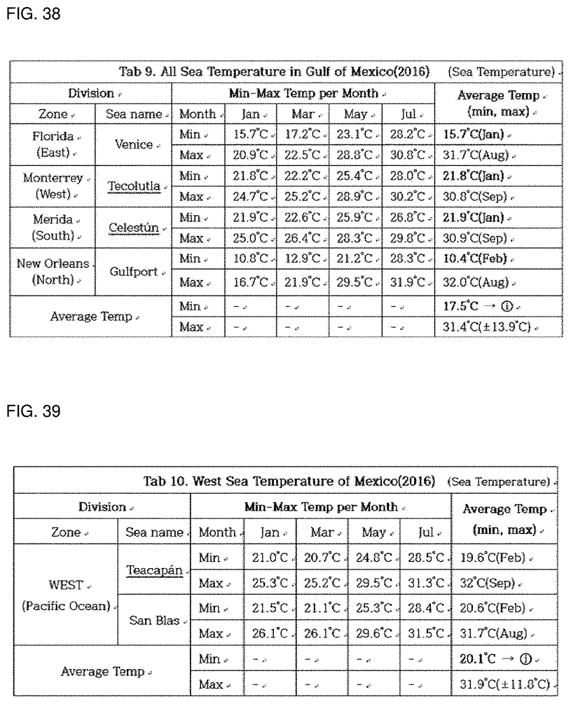

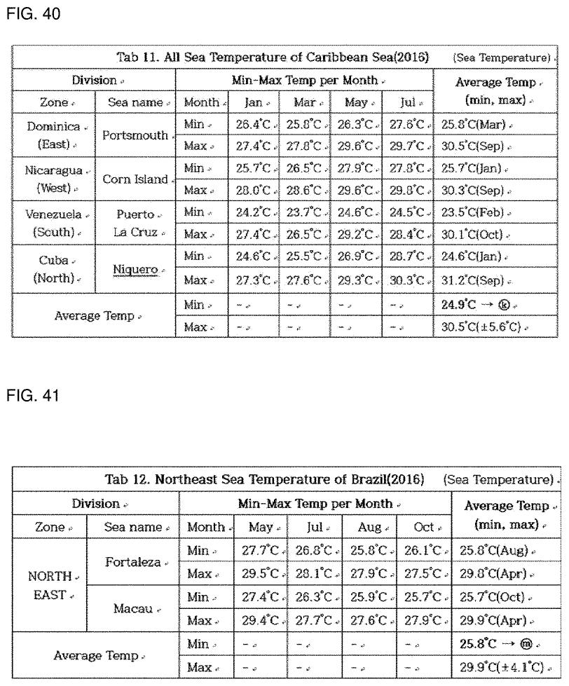

As shown in FIGS. 36 and 39, the difference between the seawater temperature in the eastern Gulf of Mexico (Atlantic Ocean) at 28° north latitude and the minimum seawater temperature in the western Gulf of Mexico (Pacific) is 1.6° C. (=21.7° C.−20.1° C.), which is the normal temperature difference. However, in the west of the Gulf of Mexico, the east-west difference in seawater temperature is 9.4° C. (=21.3° C.−11.9° C.) as shown in FIG. 37, the difference between the minimum temperature of the north and south seawater is 11.5° C. (=21.9° C.−10.4° C.) as shown in FIG. 38, and the latitude difference is 7° in FIGS. 38 and 40. However, the difference between the minimum seawater temperature in the Gulf of Mexico and the minimum seawater temperature in the Caribbean Sea is 7.4° C. (=24.9° C.−17.5° C., westerlies and easterlies collide with each other in the northeast and southwest directions, thereby preventing El Niño and La Niña from occurring.

In FIGS. 33 and 34, the difference in the minimum seawater temperature between the New Guinea Island and the coast of Ecuador is 6.4° C. (=28° C.−21.6° C.), the difference between the lowest temperature of the eastern seawater and the western seawater of the Florida Peninsula is 6.3° C. (=21.7° C.−15.4° C.) in FIG. 36 including the sea water temperature in the Gulf of Mexico, and the difference between the minimum temperature of the east and west sea water in the Gulf of Mexico is 6.1° C. (=21.8° C.−15.7° C.), so there is the temperature difference almost the same as the conditions for the occurrence of El Niño and La Niña. Thus, small causes of El Niño and La Niña exist or occur inside the Gulf of Mexico and between the Florida Peninsula and the Caribbean Sea.

Energy of Generating Tornado and Hurricane

Tornado and Aeroblackhole in North America

As shown in FIGS. 21, 22, 23, 25, 26 and 27, in the Gulf of Mexico and the Caribbean Sea, extreme weather events such as small causes of El Niño and La Niña occur frequently from north to south, thereby generating cyclones, so that the generated cyclones forcefully introduce westerlies and easterlies. Accordingly, the continuous and small occurrences of the cyclones in the Gulf of Mexico including the west coast of the Florida Peninsula supply the energy of generating tornadoes. As shown in FIGS. 7, 21, 22, 23 and 26, since the warm surface current (WSC), the north equatorial current (NEC) and the southern equatorial current (SEC) are stagnant in the southern Gulf of Mexico and the southern Florida Peninsula due to the seawater driven circulation (SDC), the seawater in the Gulf of Mexico, such as an elliptical sea lake, rotates as shown in FIG. 23 to generate La Niña and introduce westerlies, easterlies, and high winds of the Rocky Mountains, to lower the sea water temperature of the northern coast of the Gulf of Mexico from an average of 17.5° C. to 10.4° C. as shown in FIGS. 38 and 26 (yellow part), thereby shrinking the occurrence of El Niño and La Niña. Thus, strange phenomena such as an aeroblackhole, in which westerlies and easterlies collide in the northeast and southwest directions, occur excessively, and accordingly, tornadoes occur without notice in the northern Gulf of Mexico as shown in FIGS. 5 to 7.

Hurricane and Aeroblackhole

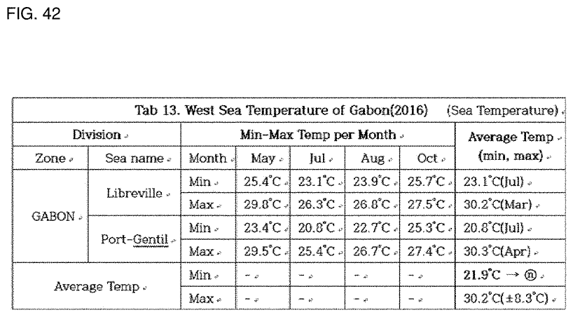

As shown in 26 and 27, the high-temperature and high-humidity low-pressure air occurring from the Caribbean Sea and the northeast of South America supplies occurrence causes of hurricanes. Since the difference in temperature of the Atlantic Ocean at the same latitude is 3.9° C. (=25.8° C.−21.9° C.) in FIGS. 41 and 42, the difference in temperature between the Gulf of Mexico and the Caribbean Sea is 7.4° C. (=24.9° C.−17.5° C.) in FIGS. 38 and 40, the warm surface current (WSC), the north equatorial current (NEC) and the southern equatorial current (SEC) of the seawater driven circulation (SDC) receive resistance from the Florida Peninsula and the Gulf of Mexico to generate heat as shown in FIGS. 7, 21 and 22, thereby generating a large tropical cyclone in the 5° to 25° north latitude region or expanding the existing cyclone, so that the local airclod (LAC) of the tropical cyclone supplies the energy of generating hurricanes through Aeroblackhole's action (ABA).

Global Warming due to Seawater Driven Circulation (SDC) and Electromagnetic Waves

As shown in FIG. 21, the warm surface current (WSC) having a length of 113,000 km generates heat in the seawater driven circulation (SDC) as shown in FIG. 7. The jet stream is heated by the stagnation of the warm surface current (WSC) together with the southern equatorial current (SEC) and the north equatorial current (NEC) in the New Guinea Island and the Florida Peninsula, and enters a low pressure region having significantly increased air temperature, thereby adjusting the difference in air temperature. The rapid inflow of the jet stream accelerates the rotational speed of the local air mass (LAM) to supply the energy of generating tornadoes, yellow dust, hurricanes, and typhoons rotating in the opposite direction according to the principle of gear (POG). According to the butterfly effect (BUFE) related to the law of geared causality (LAGEC) and the principle of Pascal (PAP) of generating large forces with small forces, tornadoes, yellow dust, hurricanes, typhoons occur, and aerial disasters such as drought, forest fire, heat wave, cold wave and heavy snow, violent rain and deluge also occur. Since global warming and glacial thawing are caused by electromagnetic waves (EMW), and the function of jet stream is being reduced due to the abuse of jet stream by aircrafts, the energy of global warming is increasing (see “Global warming by electromagnetic waves and aircrafts”).

Undersea Tunnel

Purpose of Undersea Tunnel

The present invention provides, as a technical solution, the undersea tunnel that disperses and weakens the energy of generating tropical cyclones, polar cyclones, and El Niño and La Niña generated by the seawater driven circulation (SDC) as shown in FIGS. 7 and 21 to 24, thereby dispersing and weakening the energy of tornadoes, hurricanes and typhoons to protect human lives and properties. Tornadoes and hurricanes occur due to El Niño in the Atlantic and eastern Pacific Oceans, and typhoons and monsoons occur in the Western Pacific and Indian Oceans according to El Niño and La Niña.

Size of Undersea Tunnel

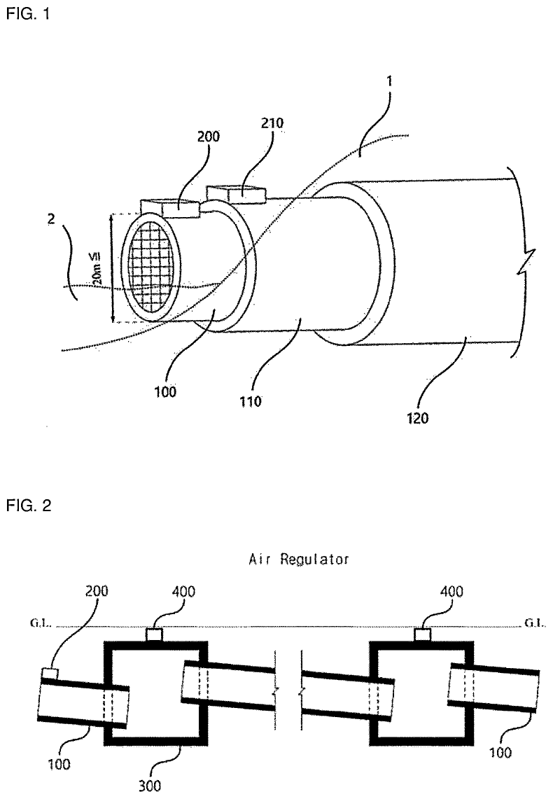

When the length of the warm surface current (WSC) is 113,000 km as shown in FIG. 21 and the flow rate is 0.5 m·s⁻¹, it takes 2,616 days (≈113,000 km÷ 0.0005 km·s⁻¹÷24÷ 60÷ 60·s⁻¹) for 113,000 km of the warm surface current (WSC) to make one revolution around the Earth. When the height of the warm surface current (WSC) is 40 m and the width is 100 m, the sectional area is 0.004 km² (=0.04 km×0.1 km), and the amount of movement in 1 second becomes 2×10 −6 km³·s⁻¹ (=0.004 m²×0.0005 k·ms⁻¹). When the diameter of the undersea tunnel is 20 m and the flow rate is based on the Law of constancy of mass, Bernoulli's equation, and coefficient of kinematic viscosity, since the undersea tunnel is circular as shown in FIGS. 1 and 2 the flow rate becomes 1.57 m·s⁻¹ (=0.5 m·s⁻¹×3.14×1.0), and the amount of seawater moved by five undersea tunnels in 1 second becomes 2.46×10 −6 km³·s⁻¹ (≈0.01 km×0.01 km×3.14×0.00157 k·ms⁻¹×5). The flow rate of the warm surface current (WSC) to be moved is 2×10 −6 km³·s⁻¹, and the flow rate to be circulated by the five undersea tunnels is 2.46×10 −6 km³·s⁻¹. Thus, the ratio of 2×10 −6 km³·s⁻¹ to 2.46×10 −6 km³·s⁻¹ is 1.23 (=2.46×10 −6÷2×10 −6), and accordingly, there is a margin of 23%. Accordingly, the number of undersea tunnels is calculated to be five as shown in FIGS. 3 and 4.

Undersea Tunnels in Florida Peninsula and New Guinea Island

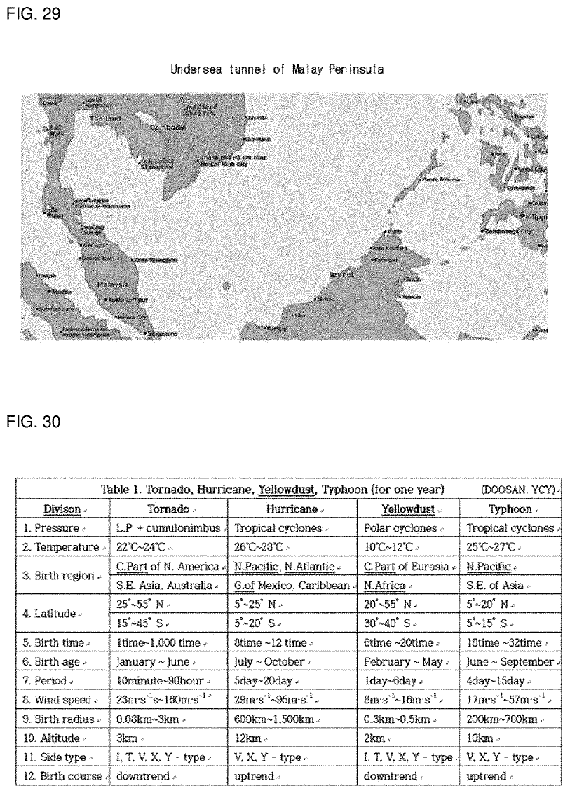

As shown in FIGS. 7 and 22, in the western seas of Peru and Ecuador in the eastern Pacific, the phenomenon of high water temperature in which the sea water temperature rises by 0.5° C. or more for 5 months from the normal year is El Niño, and the phenomenon of falling is La Niña. When the SDC is strong, El Niño occurs, and when the SDC weakens, La Niña occurs. It is said that El Niño occurs when easterlies in the northern hemisphere weaken. However, energy generated when the warm surface current (WSC), the north equatorial current (NEC) and the southern equatorial current (SEC) receive the resistance of the Florida Peninsula as shown in FIGS. 21 to 23 and 25 to 26 due to the seawater driven circulation (SDC) shown in FIG. 7, and energy generated when the warm surface current (WSC), the north equatorial current (NEC), the southern equatorial current (SEC), the equatorial counter current (ECC), and the equatorial undercurrent (EUC) receive the resistance of the New Guinea Island as shown in FIGS. 24, 25 and 28 generate El Niño and La Niña in the Pacific ocean and the Gulf of Mexico in the east-west direction as shown in FIG. 7 along with the movement direction (FIG. 21) of the warm surface current (WSC), and generate El Niño and La Niña in the north-south direction between the Caribbean Sea and the Gulf of Mexico, thereby supplying the energy of generating hurricanes and typhoons and also supplying the energy of generating tornadoes through the aeroblackhole's action in the Gulf of Mexico. Five undersea tunnels having a diameter of 20 m as shown in FIG. 1 are installed between 30 m and 60 m of water depth in the Florida Peninsula in which the warm surface current (WSC), the north equatorial current (NEC) and the south equatorial current (SEC) are stagnant as shown in FIGS. 21 to 23 and 25 to 26, and the New Guinea Island in which the warm surface current (WSC), the north equatorial current (NEC), the southern equatorial current (SEC), the equatorial counter current (ECC), and the equatorial undercurrent (EUC) are stagnant as shown in FIGS. 21, 22, 24, 25 and 28, so that the five undersea tunnels prevent the stagnation and aeroblackhole of the warm surface current (WSC), the north equatorial current (NEC), the southern equatorial current (SEC), the equatorial counter current (ECC), and the equatorial undercurrent (EUC), so as to reduce the inflow of the easterlies, the westerlies, and the polar jet stream (PJS), thereby adjusting the generating energy by dispersing the energy of generating hurricanes, typhoons and tornadoes and reducing the number of occurrences thereof. (The undersea tunnel in the Malay Peninusla related to the Monsoon of the Indian Ocean is required to be installed according to FIG. 29).

Hereinafter, the embodiments of the present invention will be described in detail with reference to the accompanying drawings.

FIG. 1 is a representative diagram of an undersea tunnel system.

Referring to FIG. 1, the undersea tunnel is configured to have a part buried under the ground 1 and have an end exposed to the outside so that the seawater 2 may move through the undersea tunnel.

FIG. 1 schematically shows that the undersea tunnel has a diameter of at least 20 meters and a pipe portion of the tunnel can be built with three types of materials. The pipe portion of the tunnel may be built with steel materials 100, concrete materials 110, or rock materials 120 depending on conditions of the sea and land in which the tunnel is built. In addition, the tunnel may be configured to include a first regulator 200 capable of manipulating gratings and floodgates provided in the undersea tunnel.

In one embodiment, the undersea tunnel system for reducing typhoon, hurricane, and tornado disasters includes: an undersea tunnel through which seawater can pass; a floodgate for controlling entrances and exits of the seawater passing through the undersea tunnel; a first regulator for regulating openings and closings of the gratings and floodgates; at least one water pressure machine (air regulator) for regulating a flow rate and a water pressure of the seawater passing through the undersea tunnel; and a second regulator for regulating an output and an air pressure of the water pressure machine (air regulator).

In addition, the floodgate may be a mechanical opening and closing device, or may be a hydraulic opening and closing device, and the present invention is not limited thereto.

In addition, the mechanical opening and closing device may include a frame, a motor, a transmission shaft, a bearing, a speed reducer, a drum, a wire rope, a manual operation device, a limit switch, a torque shaft, a sheave, and a dogging device.

In addition, the hydraulic opening and closing device may include a cylinder tube, a piston rod, a piston, a hydraulic pipe, a frame, a hydraulic activating device, a manual operation device, a bearing, and a dogging device.

In addition, the floodgate may include: a gate leaf having components including a main beam, an auxiliary beam, a watertight seal, a skin plate, a main roller, a side roller and an arm; a guide frame having components including a sealing frame, a sill beam, and a side roller passage; and an anchorage having components including a trunnion girder, a trunnion pin, and a trunnion hub.

An object of the undersea tunnel system is to reduce the occurrence frequency of typhoon, hurricane, and tornado disasters and weaken the occurrence scale and prevent human lives and properties from being destroyed. In order to perform the above object, specifically, the technology is configured to prevent the formation of a low pressure zone that is the root cause of the typhoon, hurricane and tornado disasters.

In a viewpoint of the global meteorological scale, the typhoon and hurricane disasters are thermodynamic phenomena that occur to resolve the thermal imbalance caused when thermal energy including radiant energy from the sun is concentrated only in some areas.

Accordingly, the undersea tunnel through which warm surface currents and high-temperature currents can flow is constructed in a specific area where ocean the currents are discontinued in order to distribute the thermal energy concentrated in some areas, thereby facilitating the thermal energy to be distributed with balance and weakened.

FIG. 2 is a mechanical conceptual diagram of the undersea tunnel system.

In one embodiment, the undersea tunnel may include a grating for filtering foreign substances contained in the seawater introduced through the floodgate.

In one embodiment, the grating may be accommodated according to the operation.

In addition, the grating may further include a sensor for detecting a water temperature or marine life and a grating control unit.

In one embodiment, the undersea tunnel may be formed of a material including one of steel, concrete, and rock depending on conditions of sea and land.

In addition, the undersea tunnel is formed using iron materials in the sea, built with concrete materials at a soil area, and constructed with rock at a rock area, in which a weak part of the rock is reinforced by the lining process.

In one embodiment, the water pressure machine may be provided such that three water pressure machines are installed at intervals of 2 km to 5 km in the undersea tunnel.

Accordingly, one to three water pressure machines (air regulators) and floodgates may be installed throughout inlet sections of the undersea tunnel system, and the first regulator for controlling the floodgate and the second regulator described later may be operated in a complementary manner to each other based on seawater flows of the entire system.

In addition, the water pressure machines (air regulators) may be installed at intervals of 2 km to 5 km or less in a specific section of the undersea tunnel.

In addition, the water pressure machine (air regulator) may be operated in a direction to speed up or slow the flow of seawater passing through the undersea tunnel according to operations of the second regulator described later.

In one embodiment, when the material of the undersea tunnel is soft rock, the undersea tunnel may be reinforced at the inside of the tunnel by the lining process.

According to one embodiment the first regulator may include a water temperature detection module for detecting a water temperature, a flow rate detection module for detecting a flow rate of ocean current, and a data transmission module for transmitting data collected from the water temperature detection module to at least one external device.

In addition, information measured by the water temperature detection module, the flow rate detection module and a biometric detection module may be transmitted to the external device by the transmission module and constructed as a database.

In one embodiment, the first regulator may be connected to a computer capable of processing and calculating information of the constructed database.

In addition, the computer is configured to track information about the water temperature adjusted by the undersea tunnel compared to the normal year, and perform regression analysis on the information about water temperatures and locations, frequencies and scales of the typhoon, hurricane and tornado disasters, so as to generate information about the causal relationship between the regulated amounts of water temperature and the occurrence of typhoon, hurricane and tornado disasters.

according to one embodiment the second regulator may include a water temperature detection module for detecting a water temperature, a flow rate detection module for detecting a flow rate of ocean current, and a data transmission module for transmitting data collected from the water temperature detection module and the flow rate detection module to at least one external device

In addition, the second regulator may regulate the output of the water pressure machine (air regulator), based on the information collected by the water temperature detection module, the flow rate detection module and the biometric detection module.

According to one embodiment, the undersea tunnel may include a weather condition detection module for obtaining information about water temperatures, flow rates, and weathers outside the sea level at both ends of the undersea tunnel, a data reception module for obtaining information from the first and second regulators, a data processing module for obtaining data from the weather condition detection module and the data reception module to process amounts of seawater passing through the undersea tunnel, and a control module for obtaining the data from the data processing module to determine operation values of the first regulator and the second regulator.

In addition, the data processing module may establish a database based on the information obtained from the weather condition detection module and the first and second regulators.

In addition, the data processing module may, based on the established database, perform multiple regression analysis for calculating amounts of water temperature required to be regulated in order to reduce the frequency, scale, and location of the typhoon and hurricane disasters.

In addition, various statistical techniques, which correspond to conventional techniques, may be utilized in the process of performing the regression analysis.

It is widely known that, typhoons, hurricanes, tornadoes and the like occur on a global scale when short-term heat exchange is required to resolve large-scale thermal imbalances occurring by latitude.

A lot of causal relationships related to the occurrence and fluctuation of the weather conditions are not clearly defined. However, the undersea tunnel functions as a means to resolve the global-scaled thermal imbalance, so specifically, the causal relationship can be figured out by simplifying the causal relationship, for example, between the inflow amounts of seawater and changes in water temperature or between the inflow amounts of seawater and the frequency of natural disasters.

In addition, the data processing module may simulate the flow of seawater for minimizing the probability of typhoon and hurricane disasters based on the data collected by the weather condition detection module, and may, based thereon, determine control values of the first regulator and the second regulator.

For example, when the formation of low-pressure zone is observed or predicted in a sea area at one end of the undersea tunnel, the first regulator may minimize the occurrence or magnitude of typhoon, hurricane and tornado through manipulations such as completely opening floodgates or entirely or partially closing the floodgates.

According to one embodiment, the undersea tunnel may have an overall gradient in a range of 1/5000 to 1/3000. The water pressure machine (air regulator) may have a gradient in a range of 1/300 to 1/200 between the water pressure machines.

FIG. 3 simply shows preferably selected construction locations of undersea tunnels for allowing continuous flows of warm surface currents, equatorial currents, north equatorial currents, and south equatorial currents having pathways blocked by the Florida Peninsula.

When the undersea tunnels are constructed at the location shown in FIG. 3, tropical cyclone generated and collected on the equator of the Atlantic Ocean may be distributed.

FIG. 4 simply shows preferably selected construction locations of undersea tunnels for allowing continuous flows of warm surface currents, equatorial currents, and south equatorial currents having pathways blocked by the New Guinea Island.

When the undersea tunnels are constructed at the location shown in FIG. 4, tropical cyclone generated and collected on the western Pacific Ocean may be distributed and weakened.

Although the exemplary embodiments of the present invention have been described with reference to the accompanying drawings, it will be apparent that a person having ordinary skill in the art may carry out various deformations and modifications within the scope without departing from the idea of the present invention, the following claims and equivalents thereof.

Therefore, the above described embodiments will be understood in all respects as illustrative and not restrictive.

1. An undersea tunnel system for reducing typhoon, hurricane and tornado disasters caused by interfering with passages of warm surface currents (WSC) and surface layer currents (SLC), the undersea tunnel system comprising:
an undersea tunnel through which the WSC and the SLC are configured to pass between 28° 30′N and 30° 30′N of the Florida Peninsula, between 134° E and 135° 30′E the New Guinea Island and between 146° E and 150° E of the New Guinea Island in the Florida Peninsula and the New Guinea Island;
a floodgate for controlling entrances and exits of the WSC and the SLC passing through the undersea tunnel;
a first regulator for controlling openings and closings of the floodgate and a grating;
at least one water pressure machine (air regulator) for regulating flow rates and water pressures of the WSC and the SLC passing through the undersea tunnel; and
a second regulator for regulating pressure of the water pressure machine,
wherein the first and second regulators include:
a water temperature detection module for detecting water temperatures of the WSC and the SLC;
a flow rate detection module for detecting flow rates of the WSC and the SLC; and
a data transmission module for transmitting data collected from the water temperature detection module, the flow rate detection module, and a biometric detection module to at least one external device,
further comprising:
a weather condition detection module for obtaining information about water temperatures and flow rates at both ends of the undersea tunnel;
a data reception module for obtaining information from the first regulator and the second regulator;
a data processing module for obtaining data from the weather condition detection module and the data reception module to process data about amounts of seawater of the WSC and amounts of seawater of the SLC passing through the undersea tunnel; and
a control module for obtaining the data from the data processing module to determine operation values of the first regulator and the second regulator, and
further comprising:
a computer that tracks information about water temperatures probed through the undersea tunnel, and
performs regression analysis on the information about the water temperature, and occurrence locations, occurrence frequencies and scales of the typhoon, hurricane and tornado disasters caused by interfering with the passage of the WSC and the SLC, so as to generate information about a causal relationship between amounts of regulated water temperature and the occurrence of the typhoon, hurricane and tornado disasters caused by interfering with the passage of the WSC and the SLC, wherein
the data processing module performs regression analysis for calculating passage amounts of the WSC and the SLC based on a database established on a basis of the information of the first and second regulators, in which the passage amounts are required to be regulated to reduce the frequency and the scale of the typhoon, hurricane and tornado disasters caused by interfering with the passage of the WSC and the SLC.

2. The undersea tunnel system of claim 1, wherein the undersea tunnel includes a grating for filtering foreign substances contained in the WSC and the SLC introduced through the floodgate, and the first regulator regulates openings and closings of the grating.

3. The undersea tunnel system of claim 1, wherein the undersea tunnel is formed of one of steel, concrete, and rock depending on conditions of sea and land.

4. The undersea tunnel system of claim 1, wherein three water pressure machines are installed at intervals of 2 km to 5 km in the undersea tunnel.

5. The undersea tunnel system of claim 3, wherein, when the undersea tunnel is formed of rock, an inside of the undersea tunnel is reinforced through a lining process.

6. The undersea tunnel system of claim 1, wherein the undersea tunnel has an overall gradient in a range of 1/5000 to 1/3000, and the water pressure machine has a gradient in a range of 1/300 to 1/200 between the water pressure machines.
